(19) United States
(12) Patent Application Publication
(10) Pub. No.: US 2012/0078648 A1
(43) Pub. Date: Mar. 29, 2012

(54) Method and apparatus for analyzing data on medical agents and devices

(76) Inventor: Bruce Reiner, Berlin, MD (US)

(21) Appl. No.: 13/200,545

(22) Filed: Sep. 26, 2011

Related U.S. Application Data
(60) Provisional application No. 61/344,736, filed on Sep. 24, 2010.

(51) Int. Cl. G06Q 50/22

(52) U.S. Cl. 705/2

(57) ABSTRACT

The present invention relates to an itemized analytical tool which creates a series of standardized and objective metrics related to each individual step in the overall process of pharmaceutical development and delivery. The individual steps can be divided into two main sections: pre and post regulatory approval. Pre-approval data analysis relates to the various steps involved in clinical trials, while post-approval analysis relates the multiple steps related to everyday use. The data analytics take into account the various contributions individual stakeholders and institutions play in determining overall safety and effectiveness of medical agents. The agent-specific data can in turn be cross referenced with individual patient and disease specific data, in order to provide customizable decision support.

### CROSS-REFERENCE TO RELATED APPLICATIONS

This application claims priority from U.S. Provisional Patent Application No. 61/344,736, dated Sep. 24, 2010, the contents of which are herein incorporated by reference in their entirety.

### BACKGROUND OF THE INVENTION

1. Field of the Invention

The present invention relates to methodology for longitudinally analyzing medical agents, beginning at the time of product inception and extending to clinical care delivery. This data-driven analysis not only analyzes the individual and collective steps of each medical agent, but also analyzes the individual and collective roles of each stakeholder. The end result is a standardized, objective, and data-driven analytical tool providing quantitative analysis of medical agent safety, effectiveness, and cost, taking into account the individual steps and players involved in healthcare delivery.

2. Description of the Related Art

In current medical practice, the assessment of pharmaceutical and medical device (i.e., medical agent) safety and efficacy are largely empiric in nature. Evaluation is based upon large community studies, which do not take into account individual patient variability—which is the premise of personalized medicine. A number of patient-specific variables including genetic variability, demographics, co-morbidity, and body habitus play a critical role in determining the relative safety and efficacy of different medical agents. With the increasing sophistication of medical informatics and data mining, creating standardized databases which can track quality and safety metrics referable to individual medical agents and patients becomes a reality.

Medical related errors have been highly publicized in a number of Institute of Medicine (IOM) publications, which have called for sweeping reforms to healthcare practice aimed at reducing medical errors, improving clinical effectiveness, and eliminating wasteful spending. The current practice of Evidence Based Medicine (EBM) calls for the development of best clinical practice guidelines, based upon objective data-driven analysis. In order to accomplish this, however, it is imperative that large-scale standardized data be collected and analyzed, while taking into account the myriad of confounding variables that impact patient safety and clinical outcomes.

Existing information system technologies, including the electronic medical record (EMR) and hospital information systems (HIS) provide the requisite technology infrastructure to objectively analyze medical agents, healthcare professionals, and individual patients' profiles. By analyzing the relationship between these variables, trends can be established which begin to elucidate safety and quality guidelines, specific to patient, institutional, and disease variability.

In addition to safety and clinical effectiveness, a third (often understated) priority in optimizing selection and delivery of medical agents is cost. With increasing attention to healthcare inflation, third party payers (including the government) are constantly looking for ways to reduce healthcare costs without sacrificing patient safety and clinical effectiveness. This has led to the creation of new initiatives such as Pay for Performance (P4P), which strives to create targeted financial incentives to service providers with higher quality deliverables without increasing overall costs. The desire to reduce cumulative healthcare costs is not without peril, and can arguably lead to an eventual commoditization within medicine, which prioritizes cost over quality. If optimized medical practice strives to simultaneously improve patient safety, clinical effectiveness, and cost of delivery, new strategies are required. Using data-derived analytics, it is possible to identify best clinical practice at the most affordable price, which is the ultimate goal.

The advantages of the present invention can be best understood by reviewing the existing deficiencies within the pharmaceutical (and medical device) industries. In terms of product safety, one of the biggest challenges (and dangers) facing manufacturers, service providers, and healthcare consumers today is the wide-scale counterfeiting and adulteration of pharmaceuticals. The World Health Organization (WHO) estimates that 5-10% of all pharmaceuticals are counterfeit and this is increasing in developing countries like Asia and Africa. There are four basic categories of pharmaceutical counterfeits including:

1. Completely fraudulent medications with no active ingredients or clinical benefit.

2. Counterfeit medications containing poor quality of diluted active ingredients.

3. Expired medications which are re-packaged and re-sold.

4. Medications mimicking pharmaceutical formula using unknown ingredients and/or manufacturing.

The widespread use of unsafe or toxic materials in the manufacturing process, coupled with the lack of regulatory oversight and quality control become of even greater concern as pharmaceutical manufacturers rely more heavily on global outsourcing in manufacturing and supply chain. The lack of a standardized mechanisms to record, track, and analyze pharmaceutical safety and clinical effectiveness data is both a determinant and potential solution which can be achieved by the present invention.

In addition to safety and clinical effectiveness data, it is also beneficial to incorporate economic data into the overall analysis as a means to improve cost-efficacy and counter-act criminal activity. Global organized crime networks (using the Internet) have realized the high rate of return (i.e., profitability) associated with pharmaceutical counterfeiting.

At the same time, some pharmaceutical companies reportedly often engage in a number of fraudulent activities related to pharmaceutical pricing, reporting, marketing, and kickbacks. These reported activities include erroneous reporting of “best price”, average wholesale price, and average manufacturer price, which have all been shown to adversely affect government rebates under the Medicaid Rebate Statute. At the same time, promotion of off-label usage has been shown to illegally increase pharmaceutical sales and be subject to financial penalties. Manufacturers reportedly sometimes deviate from the established manufacturing procedures and controls established by the Food and Drug Administration (FDA), resulting in adulterated pharmaceuticals. Lastly, some pharmaceutical or medical device companies reportedly will often provide financial compensation (i.e., kickbacks) to hospitals or physicians for prescribing their products.

The only reliable way to counter-act the above fraudulent activities is to track, record, and analyze data throughout the supply chain and hold each individual party accountable to their respective role/s in ensuring quality and clinical effectiveness. Further, the ability to perform trending analysis and large sample size statistics (through meta-analysis), provides better understanding as to inherent deficiencies, contributing factors, and responsible parties. While technologies currently exist to record individual data points, a standardized methodology does not exist to individually and collectively analyze all steps and stakeholders within the collective process, which is the purpose of the present invention.

### BRIEF DESCRIPTION OF THE DRAWINGS

FIG. 1 is a schematic of the computer system according to the present invention.

FIGS. 2A-2C are flowcharts for analyzing medical agents and devices to provide scores on same.

FIG. 3 is a flowchart for updating a user education profile.

FIGS. 4A-4B are flowcharts for updating policy and security controls on medical device and agent administration.

FIGS. 5A-5B are flowcharts for determining discrepancies in the handling of medical devices and agents, and performing analyses on same.

### SUMMARY OF THE INVENTION

The present invention creates a prospective methodology for longitudinally analyzing medical agents, beginning at the time of product inception and extending to clinical care delivery. This data-driven analysis not only analyzes the individual and collective steps of each medical agent and device, but also analyzes the individual and collective roles of each stakeholder. The end result is a standardized, objective, and data-driven analytical tool providing quantitative analysis of medical agent/device safety, effectiveness, and cost, taking into account the individual steps and players involved in healthcare delivery. The standardized data contained within the analyses performed, provides a tool for enhanced medical education, informed healthcare decision-making, quantitative accountability, and development of new pharmaceuticals and medical devices.

Although technology aimed at performing pharmaceutical and medical device safety and clinical effectiveness measurements exist, they have not been implemented in a way which assists the user in determining overall issues with respect to safety and quality-related measures. These issues include authentication of users, tampering with medical devices/agents and tracking of same, including authentication technologies (i.e., pharmaceutical sensors, molecular fingerprint readers, elemental analyzers), track and trace technologies (i.e., barcodes, RFID tags, watermarks, holograms, serialized numerical indentifiers), and preventative technologies (i.e., unit of use packaging, tamper-evident packaging).

These technologies and their associated data are largely independent and stand-alone—performing specific tasks in isolation to the comprehensive, stepwise process involved in the lifetime of a given pharmaceutical or medical device (i.e., R&D (approval), manufacturing, distribution, procurement, ordering, dispersal, administration, outcomes, and intervention), and thus, the present invention encompasses all these areas in one program that will simplify issues for the healthcare provider.

In order to accurately and reliably measure the relative safety and clinical effectiveness of a given pharmaceutical or medical device, the present invention provides an objective and data-driven methodology which is created to analyze each individual step in the cumulative process and to identify specific points of failure and limiting factors. By doing so, educated and informed decision making can be performed on the part of healthcare consumers, while also providing process improvement and educational data to manufacturers and healthcare providers. Thus, one objective of the present invention is to create a methodology to facilitate recording, authentication, storage, analysis and presentation of data attributable to pharmaceutical or medical device safety, clinical effectiveness, and economics.

In addition to providing a comprehensive and objective methodology for evaluating these products, the present invention provides comprehensive and objective analysis of service delivery, by individual and collective analysis of the various stakeholders involved in the chain of events (i.e., life cycle outlined above). These individual stakeholders, such as manufacturers, researchers/investigators, epidemiologists/statisticians, chemists/toxicologists, nurses, administrators, transporters/procurement personnel, information technology (IT) specialists, payers), who can also be the subjects of objective analysis, related to safety, clinical effectiveness, and economics. The combined databases of the present invention provide an objective tool for analyzing both product and service performance.

Along with the ability to prospectively analyze clinical efficacy, quality, and economic metrics (which will be collectively referred to as “performance”) of a given pharmaceutical or medical device, the analyses derived from the program of the present invention can also be used to facilitate personalized medicine.

Clinical experience over time has shown that a given medical agent's performance can be generalized based upon large-scale statistical analysis, which is not always directly attributable to a given patient. Each individual patient is unique on a number of levels including (but not limited to) body habitus, demographics, pharmaceutical profile (i.e., list of current and past pharmaceuticals), allergies and contraindications, current disease and clinical conditions, genetics, and access/affordability to medical care delivery. By creating a standardized database which can combine pharmaceutical data across large samples of patients, providers, and institutions, the present invention can derive statistical analyses which can accurately provide customized analytics. This creates an infrastructure for informed decision-making based upon objective data-driven metrics, which can be specifically related to individual patient and provider profiles by the present invention.

There has thus been outlined, some features that are consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### DETAILED DESCRIPTION OF THE INVENTION

The present invention relates to methodology for longitudinally analyzing medical agents and devices, beginning at the time of product inception and extending to clinical care delivery. This data-driven analysis not only analyzes the individual and collective steps of each medical agent/device, but also analyzes the individual and collective roles of each stakeholder. The end result is a standardized, objective, and data-driven analytical tool providing quantitative analysis of medical agent/device safety, effectiveness, and cost, taking into account the individual steps and players involved in healthcare delivery.

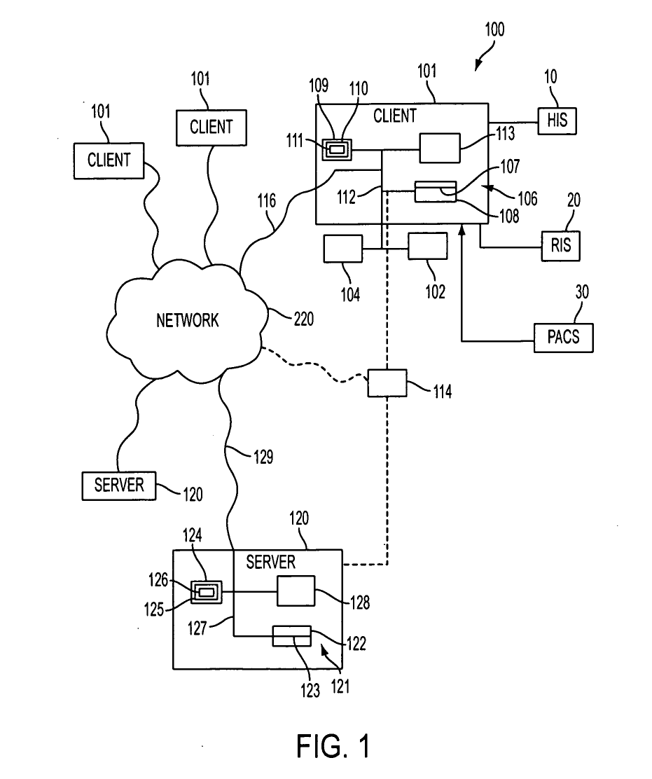

According to one embodiment of the invention illustrated in FIG. 1, medical applications may be implemented using the system 100 of the present invention. The system 100 is designed to interface with existing information systems such as a Hospital Information System (HIS) 10, a Radiology Information System (RIS) 20, and/or other information systems that may access a computed radiography (CR) cassette or direct radiography (DR) system, a Picture Archiving and Communication System (PACS) 30, inventory system 31, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the scorecard system 100 of the present invention and the information systems, such as the HIS 10, RIS 20, PACS 30, inventory system 31, etc., may be enabled to allow the scorecard system 100 to retrieve and/or provide information from/to these systems. According to one embodiment of the invention, bi-directional communication between the scorecard system 100 of the present invention and the information systems allows the scorecard system 100 to update information that is stored on the information systems. According to one embodiment of the invention, bi-directional communication between the scorecard system 100 of the present invention and the information systems allows the scorecard system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes, as described in U.S. patent application Ser. No. 11/512,199 filed on Aug. 30, 2006, the entire contents of which are hereby incorporated by reference. The multi-functional programmable stylus may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the QA scorecard system 100 may include separate programs 110 having code that performs desired operations. According to one embodiment of the invention, the program 110 that runs the scorecard system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, scorecard system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, and the PACS 30 (if separate), or inventory system 31, are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

The present invention is an itemized analytical tool which creates a series of standardized and objective metrics related to each individual step in the collective process of medical agent/device development and delivery. These steps can be divided into two main groups: 1) pre-regulatory approval; and 2) post-regulatory approval.

In the United States, the pre-regulatory approval process for medical agents/devices is under the direction of the Food and Drug Administration (FDA), and encompasses a number of clinical trials aimed at determining the relative safety and clinical effectiveness of the proposed medical agent/device. The steps involved in this approval process are collectively referred to as Clinical Trials and include the following: 1) pre-clinical studies (those involved in vitro and in vivo experiments using wide-ranging doses of the study drug/device in question, in order to obtain preliminary measures of clinical efficacy, safety, and with respect to drugs—toxicity, and pharmacokinetics); and 2) phase O (this entails exploratory, initial human trials (i.e., human micro-dosing studies with respect to drugs), aimed at establishing whether the agent/device behaves in humans as expected from pre-clinical studies.

In particular, the present invention is particularly suited for pharmaceuticals, and many of the examples will be directed to same. However, even though a particular explanation or example may address a pharmaceutical, one of ordinary skill in the art would recognize that a medical device would follow a similar example or have a similar explanation.

With respect to pharmaceuticals, the distinctive features include administration of a single sub-therapeutic dose to a small sample size, in order to gather preliminary data on pharmacokinetics and pharmacodynamics.

In Phase I, a small group of human trials is designed to assess safety (i.e., pharmacovigilence), tolerability, pharmacokinetics, and pharmacodynamics. It also includes dose-ranging (i.e., dose escalation) in order to identify therapeutic dosage, over a range of test doses.

In Phase II, larger test groups are divided into two phases, which are designed to assess dosing requirements (IIA) and assess clinical efficacy (IIB).

In Phase III, randomized, controlled, multi-center trials on large sample size groups are conducted. In addition to representing the definitive assessment of clinical efficacy (relative to the established “gold standard” treatment), it includes expanded safety data, data supporting marketing claims, and label expansion (effectiveness beyond original intended use).

Phase IV is the Post Marketing Surveillance Trial, as it often takes place after a medical agent has received approval for sale. Data included in this phase includes pharmacovigilence, testing of drug interactions, development of new markets, and testing of specialized patient groups. This is specifically designed to detect rare and long term adverse effects not shown during the Phases I-III clinical trials.

Once a medical agent has been shown to yield satisfactory results after the Phase III trials, corresponding data are combined into a large document which contains a comprehensive description of methodology, results, manufacturing processes, formulation details, and shelf life. This collective data forms the submission which is reviewed by the appropriate regulatory authorities for potential marketing approval. Since this data submission process is standardized, extraction of standardized data is achievable and can represent the Pre-Regulatory component of the scores compiled by the present invention for the pharmaceuticals and medical devices.

This pre-regulatory data recorded in the databases 113, 114 would include a stepwise series of data attributable to each of the described clinical trials, and include metrics related to safety (e.g., tolerability, drug-drug interactions, toxicity, adverse effects) and effectiveness (e.g., pharmacokinetics, pharmacodynamics, dose ranging, therapeutic response) relative to the specific clinical indications (i.e., diseases) and patient populations in which approval was granted. The ability to segment this data into specific patient profile groups is largely dependent upon the sample size of the data collected and analyzed. The fact that the present invention records, tracks, and analyzes data in a standardized format (independent of the data source and medical agent) provides an effective means in which data can be exchanged and combined across multiple clinical trains and collaborators. This creates a mechanism for meta-analysis, with large sample size statistics providing the requisite data volume for detailed patient profiling and analysis.

It is important to note that a number of individual parties (i.e., stakeholders) are involved in the collective pre-regulatory data, and these will be accounted for on an individual basis with the present invention. These parties are involved in the recruitment, methodology, performance, analysis, and reporting of clinical trial data, and include local investigators, statisticians, the sponsoring company, contract research organizations (CRO), and regulators.

The individual stakeholder responsibilities and metrics within the pre-approval component of the present invention include: 1) Contract Research Organization (CRO): a) researcher and patient recruitment, b) training, c) resource allocation, d) data collection and refinement, e) compliance monitoring, and f) Institutional Review Board (IRB) approval; 2) Local Investigators: a) patient safety, c) IRB communication, d) adherence to study protocol, e) supervision and guidance of staff, f) informed consent of study participants, and g) review and communication of adverse event data; 3) Sponsors: a) accurate and timely data sharing, b) monitoring of test results, c) collection and communication of adverse event reports from study sites, d) creation of site-specific informed consent documentation, e) outsourcing of data analysis to an independent third party expert, (e.g., Data Mining Committee, Data Safety Monitoring Board), and f) accurate reporting of financial expenditures and remuneration; 4) Regulators: a) thoroughness in study design methodology, b) quality and integrity of data, c) accuracy in study result findings and conclusions (risk/benefit analysis), c) identification of potential conflicts of interest, d) review of adverse events (including post-approval safety), and e) compliance with standards and regulations.

The various responsibilities of each party are listed below and would be integrated by the program 110 into its data analysis.

The responsibilities for the Physician would include: education and training, credentialing and licensing, ordering appropriateness, dose optimization, communication and consultation, diagnosis of adverse events, treatment of adverse events, clinical monitoring, documentation and reporting, storage and dispersal (office), security of controlled substances (office), and standards compliance.

The responsibilities for the Pharmacist would include: education and training, credentialing and licensing, inventory management, security of controlled substances, dispersal, expiration dating, operational efficiency, preparation and handling, communication and consultation, identification and authentication, assessment of drug-drug interactions, appropriateness of drug selection and dosage, support staff oversight, standards compliance, and reporting and documentation.

The responsibilities for the Administrator would include: security and confidentiality, standards compliance and regulatory oversight, education and training (staff and patients), supporting technology, database management, policies and procedures, operational efficiency, reporting and documentation of adverse events, performance review and analysis, and quality control and assurance.

The responsibilities for the Manufacturer would include: post-clinical trials reporting and documentation including a) drug-drug interactions, b) tolerability, c) toxicity, d) adverse events, and e) comparative analysis. The responsibilities would further include dose ranging, label expression, chemical purity, tamper resistant packaging, education and communication (product alerts), inventory management, pharmaceutical storage and distribution, unit cost pricing and analysis, and expiration dating.

The responsibilities for the Nurse would include: education and training, credentialing and licensing, clinical assessment, documentation and reporting, communication and consultation, administration and handling, operational efficiency, clinical monitoring, patient/drug identification and authentication, and treatment of adverse events.

The responsibilities for the Patient (compliance), would include: filling prescriptions, taking prescribed medications as directed, reporting any adverse actions or changes in health status, keeping scheduled appointments, providing requisite clinical feedback to designated healthcare professionals, utilizing healthcare technology to assist in data collection (e.g., at home glucose monitoring, blood pressure measurements), reporting lost or stolen medications, following medical directives for required clinical testing (e.g. blood work testing liver enzymes), providing accurate and updated healthcare records, reporting any change of address or location to healthcare professionals involved in medical care, and participation in educational initiatives.

The responsibilities of the Third Party Payers would include: compliance with industry and governmental standards, communication and reporting, education (patients and providers), pricing and cost analysis, contractual agreements, criteria for formulary selection, policies for generic and brand name drugs, and financial incentives and penalties.

Due to the fact that technology plays a critical role in data collection and analysis; it is important to ensure that the technology being utilized is reliable. In current practice, web-based electronic data capture (EDC) and clinical data management systems (CDMS) are commonly used in clinical trials, and are incorporated by the program 110 into the overall safety and effectiveness analysis. These technologies provide a reliable and reproducible means to facilitate standardized data collection and analysis, which is an integral component to the Scorecard.

A number of pitfalls and limitations currently exist within the regulatory review process, which can potentially be alleviated through the present invention. In the current review process, there is a well documented intrinsic bias towards positive results, with negative results often being hidden and unpublished. The present invention would negate this bias by having the program 110 record all data (both positive and negative) in the review process and by making it accessible for public dissemination. Each variable could be assigned a numerical score (e.g., using a Likert scale), which provides an easy to understand measure of how that particular agent was rated relative to a reference peer group, for the specific variable in question. This would be particularly valuable in situations where a particular pharmaceutical received FDA approval, but achieved relatively low scores in certain categories of safety or effectiveness. A prospective physician or pharmacist considering use of this pharmaceutical shortly following its FDA approval, may elect to withhold its use pending more favorable data during the post-regulatory period of data analysis.

The intrinsic bias towards positive test results can manifest itself in a number of other ways including study methodology and financial remuneration of study participants. In an attempt to yield the most favorable results for study sponsors, the methodology may be somewhat skewed. As an example, sponsors of a pharmaceutical seeking FDA approval with a marginal effectiveness profile relative to the existing “gold standard” may utilize a suboptimal dose of the “gold standard”, in order to inflate the clinical effectiveness scores of the pharmaceutical seeking approval. The data recorded by the program 110 in an analysis presented to the user as a Scorecard, could account for differences in dosage by publishing a number of data equivalents, such as Safety/Dose, Effectiveness/Dose, and Cost/Dose ratios.

In the example of Safety/Dose data, a standardized measure of safety (e.g., toxicity) can be reported by the program 110 in relationship to a standardized dose measure; thereby providing a comparative measure of safety relating to the specific dosage of the pharmaceutical which is being tested. This creates an effective counter-measure to comparing “apples and oranges”, ensuring that the derived data take into account the specific dose being used in the analysis. These same ratios (e.g., safety/dose, effectiveness/dose, and cost/dose) can also be used as important quantitative measures in the Post-Regulatory portion of the present invention. In this situation, an uninsured patient who is paying for prescriptions out-of-pocket may utilize objective Scorecard data to compare the safety and effectiveness of a given generic and brand name pharmaceutical relative to its unit dose cost, in order to make an educated and informed decision as to the preferable selection based upon available financial resources.

Another potential bias for positive test results lies in the existing financial model for drug approval. Numerous publications have shown that investigators who are paid by sponsoring companies for drug-related research tend to demonstrate a bias towards positive test results (i.e., favoring the sponsor company's drug). The only way to effectively address this potential conflict of interest is to shine a light on all stakeholders, study data, and financial remuneration. By the program 110 incorporating this data into an analysis, presented as a Scorecard, anyone reviewing the data would have direct access to the recorded data (before and after cleansing), derived analyses, and identities of the sponsoring company and paid investigators. While the data associated with any single approval application may be entirely accurate, “downstream” analysis of the data (and investigators) of the present invention will ultimately reveal any bias by correlating Pre- and Post-Regulatory data along with the historical track record of companies and investigators.

As an example, a paid investigator may attempt to improve the safety profile of a drug seeking approval by minimizing the reported drug-drug interactions. While this data may initially escape detection in the approval process, it will be ultimately uncovered during the post-regulatory data analysis. At the time this data is uncovered, questions will retrospectively be asked regarding the methodology and accuracy of data collection and analysis, along with the integrity of the investigators. The ability of the present invention to longitudinally track and analyze a medical agent's performance provides an important safeguard against bias.

At the same time, co-mingling Pre- and Post-Regulatory data provides an opportunity for the program 110 to identify undetected trends in the data at an earlier point in time then Post-Regulatory data analysis alone. As an example, a pharmaceutical's data during Phase IV may not have demonstrated a statistically significant adverse drug-drug interaction (due to the relatively small sample size). However, following approval and use in the marketplace, a number of unexpected drug-drug interactions are begun to be realized. The program 110 of the present invention could effectively identify this safety issue at an earlier date by combining the Pre- and Post-Regulatory data, along with actively promoting the recording of physician/nurse data related to safety and clinical effectiveness. The greater the frequency (and accuracy) of prospective data being recorded, the earlier unexpected analyses are detected and acted upon.

This latter feature of actively promoting data collection is a component of the Compliance section of the present invention (i.e., Scorecard), which encourages and actively monitors data input from stakeholders. In the current practice environment, information system technology does not provide an expedient (or automated) method for recording and analyzing data relative to its safety and effectiveness. If for example, a nurse administered a pharmaceutical to a patient and there was an adverse event (e.g., renal insufficiency), the nurse would likely document this event in the patient's progress notes, notify the physician, and facilitate treatment in response to the event. There would in effect be no centralized data record of the adverse event, associated intervention, and clinical outcome. With the present invention, all relevant data would be recorded by the program 110 in a single all-inclusive database 113, 114, with mandatory data inputs required by the responsible parties (e.g., nurse, pharmacist, and physician).

In addition, longitudinal clinical data (e.g., serial BUN and creatinine measures of renal function) would be incorporated by the program 110 into the database 113, 114, demonstrating the effectiveness of intervention and overall clinical outcome. If any of the involved stakeholders did not fulfill their obligation to record the required data, an automated alert would be sent by the program 110 to them notifying them of the oversight, along with a copy to the Pharmaceutical Safety committee. If the adverse event was to achieve a critical threshold (as determined by the institution), a formal review may be instituted by the program 110, which in turn could prompt disciplinary action or remedial education. The end result is that all events, data, and stakeholders involved in the collective process of pharmaceutical delivery would be recorded in a centralized database 113, 114 by the program 110, with internal checks and balances incorporated by the program 110 to ensure institutional and individual compliance.

Another limitation in the current regulatory review process which can be improved upon by the present invention is the creation of a standardized methodology for how data is recorded, tracked, analyzed, and reported. The present invention's creation of an objective methodology with well-defined metrics attributable to measures of safety, effectiveness, and cost, can create a mechanism for large scale data mining which can include both the Pre-Approval and Post-Approval portions of a pharmaceutical (or medical device) lifetime. These safety, effectiveness, and cost-related data can be cross referenced by the program 110 with individual patient, institutional, disease, and stakeholder-specific variables to create a referenceable database 113, 114 which can be used for data-derived best practice guidelines; which are the cornerstone of Evidence-Based Medicine (EBM). In the near future, an individual patient's genetic and clinical data can be cross-referenced by the program 110 with the data compiled by the present invention, for the program 110 to identify the optimal treatment options (e.g., pharmaceutical, service provider) best suited to treat his/her medical condition, based upon the program's 110 meta-analysis of the “Scorecard” data.

As an example, a physician treating a patient with newly diagnosed hypertension may have numerous (e.g., 25) anti-hypertensive medications to choose from. After consideration of the patient's other clinical diagnoses and medications being prescribed, the physician may narrow down a list of potential pharmaceutical candidates to five (5). By the program 110 searching the database 113, 114 for similar patient profiles; the program 110 would present the physician with overall safety and clinical effectiveness scores for the 5 pharmaceutical candidates in question. The physician can in turn elect to choose from this list based upon the highest collective safety and clinical effectiveness scores alone, or can elect to consider additional variables (e.g., cost, generic availability, and formulary), which the program 110 can quantify.

Once the genetic data is available and incorporated by the program 110 into the database 113, 114 analysis, the program 110 can search the database 113, 114 for safety and clinical effectiveness scores relative to similarities in patient genetic profiles. By doing so, the results may show that patients with similar genetic profiles to the patient in question, actually have different clinical responses to the hypertensive drugs in question than the population as a whole. By the program 110 incorporating the genetic data into the analysis, personalized medicine is being practiced, taking into account a number of unique patient data (e.g., body habitus, demographics, genetic and clinical data, pharmaceutical history, and disease profile). The program-derived “Scorecard” analytics would provide the ability for the physician (or other credentialed healthcare provider) to input the specific variables of interest and provide customizable multipliers (i.e., selecting the relative priority of one variable relative to another). Based upon the input data being provided and the comprehensive data contained within the database 113, 114, data-derived analytics by the program 110 would in turn be provided to the physician to facilitate decision-making.

A number of tangible benefits would be derived from the program's 110 creation of standardized analytics for the Pre-Regulatory Review process, and would include: 1) creation of useful and publicly available data standards, 2) well-defined standards adoption process, 3) assurance that regulatory data is submitted in a reproducible and objective fashion, and 4) accountability in regulatory review with elimination of potential bias related to data analysis.

Recent efforts by the Center for Drug Evaluation and Research (CDER) have begun to create comprehensive data standards along with the creation of an electronic infrastructure which would support the standardized databases 113, 114 of the present invention. For example, standardized data currently collected in drug approval applications include: a) protocol and amendments, b) identities of principal and coordinating investigators, c) audit certificates and reports, d) statistical methods and analyses, e) documentation of inter-laboratory standardization of quality assurance procedures, f) study and reference publications, g) compliance and/or drug concentration data, h) safety reports, i) patient consent forms and Institutional Review Board applications, j) listing of participating patients and dosing, k) randomization schema, l) individual efficacy response data, m) protocol deviations, n) adverse event listings, o) individual laboratory measurements and data, p) case report forms, and q) subject profiles. However, the present invention represents a significant extension in the depth and breadth of existing data standards.

Once the approval process for a given pharmaceutical or medical device has been completed, the second phase of data collection begins related to the Post-Approval phase of a medical agent's lifetime. While Pre-Approval analysis can simplistically be thought of as the R & D phase, Post-Approval analysis can simplistically be thought of as the Clinical phase in a given medical agent's lifetime. This Clinical phase entails a number of steps and analyses, including the following: a) manufacturing, b) distribution, c) procurement, d) ordering, e) dispersal, f) administration, g) outcomes, h) interventions, i) compliance, and j) education.

For a given pharmaceutical, the manufacturing step would be the sole responsibility of the industrial manufacturer and encompass the production of active ingredients, incorporation into dosage form, and packaging. The assigned metrics collected by the program 110 would include measures of pharmaceutical purity, contaminants, dose calibration, and tamper-proof packaging. During the manufacturing process, an electronic marker (e.g., RFID) can be incorporated into the pharmaceutical to record the manufacturer, location, date/time, and person responsible for quality control. At the time of random pharmacologic testing, this information would be automatically downloaded by the program 110 into the Scorecard database 113, 114 along with the recorded safety/quality metrics and identification of the examining chemist (using Biometics).

The distribution and procurement steps of the medical agent life cycle would entail all aspects related to ordering, storage, transportation and receipt of the pharmaceutical as it travels from the manufacturing site to a storage facility and onto the receiving pharmacy of record. Metrics for analysis that are collected by the program 110, would include the accuracy and reliability of time stamped data, documentation of all movements of the pharmaceutical and involved personnel, and inventory management to ensure any lost, stolen, or damaged pharmaceuticals are accounted for. An additional step related to procurement would be accurate tracking of pharmaceutical storage and expiration requirements by the program 110. Compliance with regulatory and industry standards would be an integral component of these steps; which is especially important for controlled substances. Additional layers of documentation would be required to ensure security and safety as it relates to transportation and procurement, and include education, training, and vetting of all involved parties. All pharmaceutical transactions could be automatically recorded by the program 110 using available tracking and tracing technologies, biometrics for end-user identification and authentication, and information system technologies.

For inventory management using an inventory system 31, automated protocols and standards could be integrated directly into electronic surveillance by the program 110, which would be customized for each individual pharmaceutical. An automated prompt or alert could be recorded and transmitted by the program 110 in the event that an outlier was identified (e.g., storage temperature exceeded pre-determined threshold, expiration date was approaching) in order to initiate appropriate intervention. The responsible party receiving and acknowledging receipt of the alert, would in turn be expected to follow established guidelines and document any deviation from protocol. The derived compliance metrics would in turn be attributable to the institution of record (e.g., hospital pharmacy), individual stakeholders (e.g., pharmacist), and compliance officer. In the event that a pre-defined threshold of non-compliance was registered (which would be defined by both frequency and severity of the events) and recognized by the program 110, an automated alert would be sent by the program 110 to the responsible authorities (e.g., National Association of Boards of Pharmacy) for investigation and action.

The ordering step would be the responsibility of the physician and/or pharmacist; who are tasked with clinical evaluation of the patient and determination of the optimal type and dosage of a given pharmaceutical for treatment. Safety considerations would include patient-specific drug allergies, drug-drug interactions, adverse clinical events, clinical indication, and dose optimization. Effectiveness considerations include selection of the appropriate medication (given the patient's clinical profile), appropriate dosage, and timely/accurate communication. Existing information system technologies (e.g., Pharmacy Information System (PIS), Electronic Medical Record (EMR)) and the data contained within them could be directly integrated by the program 110 into the databases 113, 114 and decision support applications to ensure consistency and completeness of the data being recorded and analyzed among disparate databases 113, 114. In the event that conflicting data was recorded (e.g., two different doses for a given pharmaceutical), an automated alert would be sent by the program 110 to the ordering physician and pharmacist of record to require clarification. In the event that an established standard of care was over-ridden (e.g., off label usage, excessive dosage for a given clinical indication), an automated prompt would be sent by the program 110, requiring additional investigation and/or justification prior to approval and fulfillment of the order.

Dispersal entails delivery/transfer of the pharmaceutical from the pharmacy to the patient or patient advocate. For a hospital in-patient, the various steps would include filling the prescribed order (after verifying patient-specific safety and clinical effectiveness concerns) by the pharmacist, transporting the pharmaceutical to the patient's medical unit, and documenting receipt by clerical staff or nursing. For an out-patient, dispersal would consist of filling the prescribed order and documenting receipt by the patient. The requisite data requirements to ensure adequate safety would be somewhat different, in accordance with the individual pharmaceutical and patient of record. As an example, a highly toxic pharmaceutical (e.g., chemotherapy) would require multi-party documentation as to the agent, dosage, and method of preparation, whereas an antibiotic with a high safety profile (i.e., low toxicity, few adverse events) would require single party documentation. Form the patient perspective, safety measures may vary in accordance with the pharmaceutical and individual patient profile. As an example, an outpatient receiving a controlled substance (e.g. Oxycontin™) would require more extensive scrutiny and documentation of their identification and understanding of appropriate usage, then an outpatient receiving an anti-inflammatory drug. At the same time, a patient with a past medical history of prescription or recreational drug addiction would require far more scrutiny than patients with no prior elicit drug history, which are being prescribed the same medication. This underscores an important principle of the Scorecard of the present invention, and associated metrics for analysis—i.e., data requirements differ in accordance with the individual patient and pharmaceutical profiles.

The metrics for analysis in the Dispersal category would include operational efficiency (e.g., time from prescription receipt to delivery), authentication of involved parties, receipt documentation of educational material, and accuracy/completeness in filling the prescribed order.

Administration involves the actual intake of the prescribed medication, which can take place in a number of delivery modes (e.g., intravenous, oral). For an inpatient, a number of required data documentations must be entered into the database 113, 114 by the program 110 to ensure optimal safety, including (but not limited to) the following: a) identification and authentication of all involved parties, 2) location, date, and time of administration (including beginning and end times), 3) pharmaceutical administration consistent with order and standard of care, 4) informed consent of patient/or advocate, 5) communication between involved parties, and 6) successful completion (if not, cause and action taken).

For an outpatient, the required data is different, and focuses on patient compliance metrics, which include the program 110 storing information in the database 113, 114 on the following: a) patient authentication, b) date and time of administration, c) deviation from prescription schedule (e.g., missed or incorrect doses), and d) communication with responsible caregivers (e.g., physician, nurse).

Supporting technology can be utilized to order to ensure accurate, timely, and reproducible data is recorded. For identification and authentication, biometrics, using any of the state-of-the art biometrics technologies, can be utilized, which can be directly integrated by the program 110 into an electronic home health device which stores pharmaceuticals and records each time an individual dose is removed, along with verification of educational aides. In the event, that a dose was missed or incorrectly taken (e.g., double dose), an automated prompt would be sent by the program 110 to the responsible healthcare provider (e.g., physician), alerting him/her of the pharmaceutical compliance issue. Any communication which subsequently took place between the patient and provider (e.g., e-mail) would be recorded into the database 113, 114 by the program 110, along with any subsequent actions taken. This compliance data would in turn be integrated into the patient profile by the program 110 and utilized for future reference and pharmaceutical decision-making.

Outcomes data analysis is one of the important components of the present invention. By the program 110 analyzing longitudinal data with the database 113, 114, data-derived best practice guidelines and EBM standards can be created by the program 110. Through cross-referencing data contained within individual patient, stakeholder, and institutional databases 113, 114 by the program 110, information can be derived by the program 110 which shows the interaction effects different profiles have on pharmaceutical safety and clinical effectiveness.

As an example, a seemingly safe and effective antibiotic (based upon large-scale statistics) can be shown to have a serious adverse action (e.g., renal failure) in a certain subset of patients (e.g., specific genetic markers, co-existing morbidity). Another example may show that the safety and clinical effectiveness data associated with a particular type of medical device (e.g., cardiac valve prosthesis) is adversely impacted for a certain subset of patients receiving placement and follow-up care at a specific institution. The Outcomes data serves as a data-driven mechanism for the program 110 to identify potential problems and provide an opportunity for improved care through a combination of education, training, and recertification of medical personnel.

The Outcomes data within the “Scorecard” of the present invention, refer to measures of clinical response relating to individual pharmaceuticals (or medical devices), and can be tracked and analyzed by the program 110 in accordance with individual stakeholders and institutions. Examples of some of the Outcomes data metrics include (but are not limited to) the following: a) toxicity, b) allergic reactions, c) side effects, d) drug-drug interactions, e) clinical effectiveness, f) expected versus unexpected, g) degree of clinical response, h) supporting data (e.g., laboratory, clinical test, signs and symptoms), and i) compliance.

To illustrate how this Outcomes metric data would be recorded and analyzed by the program 110, an example of a patient with chronic seizures, who recently has become unresponsive to his/her medical treatment, with breakthrough seizures despite compliance and appropriate dosage, is considered. As a result of the patient's status, the Clinical Effectiveness outcomes data has suffered, prompting a recommendation for change in medical therapy.

The neurologist caring for the patient now seeks to determine the optimal therapeutic agent in keeping with the patient profile, pharmaceutical history, and disease progression. In this particular case, the patient's refractory seizures, longstanding history of numerous anti-seizure medications (despite excellent compliance), and individual patient profile (age, co-existing cardiac and renal disease) all need to be considered in determining optimal medical therapy. The neurologist generates a query of the program 110, to search the database 113, 114 for such a medical therapy, and places high priority rankings on the categories of co-morbidity (cardiac and renal disease), age (71), and compliance (excellent).

The program 110 provides the neurologist with three potential pharmaceutical candidates, with detailed safety and Clinical Effectiveness data related to each of the high priority categories the neurologist has provided. The neurologist learns from the data that one pharmaceutical has particularly high Clinical Effectiveness scores, but comes with a safety concern related to toxicity. In exploring the toxicity data further (by having the program 110 query the database 113, 114 for detailed information under the toxicity category for this particular pharmaceutical), he learns that toxicity of this pharmaceutical can be minimized if the serum drug levels are maintained within narrow ranges. Realizing that the patient is highly compliant, he elects to select this pharmaceutical, with the caveat that the patient must be vigilant about taking the prescribed medication as ordered, undergo bi-weekly blood tests (to detect drug serum levels) for the first month of treatment, and be sure to communicate regularly with the neurologist regarding clinical response, side effects, and any adverse actions.

After consultation, the patient agrees with the treatment plan and starts treatment with the new anti-seizure medication. Four possible Outcome scenarios may take place, as listed below: 1) response to treatment is excellent, with no breakthrough seizures or side effects, 2) response to treatment is very good, however clinical test data (i.e., electro-encephalogram) reveals low level (sub-clinical) seizure activity, necessitating adjustment in dosage and more frequent monitoring (i.e., weekly) of serum drug levels for toxicity, or 3) response to treatment is poor, due to side effects in the form of dizziness and nausea (despite therapeutic serum levels); treatment is terminated and a new pharmaceutical is begun, and 4) response to treatment is good, however, blood work reveals worsening in renal status (e.g., elevated BUN and creatinine), necessitating discontinuation of the pharmaceutical and selection of a new treatment.

The documentation and analysis of the Outcomes data plays an integral role in the next category of Intervention. This refers to the timely identification of adverse and/or unexpected events related to pharmaceutical (or medical device) treatment and timely response to effect positive clinical outcomes. A number of metrics can be incorporated by the program 110 in this category of the Scorecard database 113, 114 and include the following: 1) timeliness in diagnosis and treatment, 2) accuracy in early detection of adverse events, 3) communication and consultation between involved parties, 4) proactive surveillance and monitoring, 5) documentation of associated data, 6) utilization of available decision support technologies, 7) education and training of stakeholders, and 8) clinical success in treatment response.

Note that in addition to the principle healthcare providers (e.g., physician, nurse), the patient is a critical determinant in the success (or lack thereof) of Intervention. As a result, the program 110 records and analyzes Intervention data related to the individual patient.

Compliance and Education categories within the database 113, 114 can be combined, since there is some overlap as to the involved metrics. The program 110 tracks data related to these categories such as individual and institutional adherence to established regulations, practice standards, and education/training expectations. The goal is to encourage and reward participants to proactively utilize available technologies and knowledge sources to enhance clinical effectiveness, safety, and economic efficacy relating to use of pharmaceuticals and medical devices.

Existing information systems technologies can be utilized by the program 110 to integrate rules based algorithms (based upon established EBM standards) into the database 113, 114 to simultaneously provide automated decision support and track individual and institutional compliance. At the same time, each individual's performance metrics can in turn be used by the program 110 to identify areas of performance deficiencies, and provide educational resources for targeted improvement. As individual stakeholders (and institutions) utilize these educational resources, they will be rewarded by receiving additional points to their collective “Scorecard” performance metrics; thereby providing an incentive to become proactively engaged. Longitudinal analysis by the program 110 will show a potential cause and effect relationship between those parties utilizing these compliance and educational resources and those who do not; thereby validating the intrinsic value of the technology of the present invention and creating an iterative method for refinement.

The Compliance and Education Metrics differ between patients and healthcare providers (e.g., physician, pharmacist), and include the following data collected by the program 110: 1) Patients: a) drug administration and refilling, b) clinical testing, c) office visits, d) communication, e) documentation of data requirements, f) utilization of database 113, 114; 2) Providers: a) compliance with established standards and regulations, b) communication and consultation, c) data documentation, d) utilization of available resources, e) continuing education and scheduled training, f) informed consent, and g) certification and licensing.

Compliance is one important feature of the database 113, 114. The present invention collects and analyzes data, to provide an effective mechanism to measure medical agent safety, clinical effectiveness, and cost efficiency. In order to ensure that the data is accurate, reproducible, and complete, data integrity measures are integrated into the database 113, 114 by the program 110. Since the databases 113, 114 are stored at local, regional, and national levels, electronic security is incorporated in the program 110 to prevent illicit data entry and modification, as well as measures to ensure all relevant data is captured and recorded into the databases 113, 114. In order to accomplish these goals, another stakeholder is involved in the analytical process—i.e., the compliance and security officer (the duties of which may be performed by a single or multiple individuals).

Data compliance and security entail the following features.

First, all relevant data to program 110 analyses are recorded and stored by the program 110 at the time of each individual step performance and/or completion. Recording and access to data contained within the database 113, 114 can only be performed by authorized and credentialed individuals; whose profiles are contained within the database 113, 114.

Routine audits on the databases 113, 114 are performed by the Compliance and Safety officers to ensure there is compliance with pre-defined data security and integrity standards. In addition to these external audits, internal audits are performed by the program 110 to identify questionable data entries or attempted access.

Pre-defined “high priority” data inputs (e.g., recording of an adverse drug event leading to patient death) are automatically flagged by the program 110 for requisite validation by authorized personnel. Further, any events deemed of questionable status (through internal/external audits) or fulfilling pre-defined “high priority” status, are automatically referred by the program 110 to the Compliance/Security committees for review and action.

In the event that attempted data entry fulfills one of the following criteria, a second verification by authorized personnel is required for data authentication. For example, the following scenarios are envisioned:

a) A high priority event (e.g., drug induced death, lost-stolen medical agents) requires a second authorized party for confirmation. In the example of a drug-induced death, both the attending physician and nurse must both document the event independent from one another.

b) A questionable data entry (which is flagged by either external (user) or internal (computer program 110) audit) is documented by the program 110 as having “questionable” status, which requires review by the Compliance/Security officer for clarification. In order to achieve a “final” status, the data in question must be authenticated by a second authorized party of record. An example might include entry of a drug dosage which is not customary for the pharmaceutical in question, or clinical indication other than is customary. In this event, a second authorized party would be required to ensure accuracy of the data input (the two parties would include the physician ordering the pharmaceutical and the pharmacist filling the order).

c) An erroneous data entry (identified by a security report completed by an independent third party) is reviewed by the Compliance/Security officer and reported as either factual (i.e., substantiated) or illicit (i.e., not substantiated). The identity of the reporting individual (i.e., data source), location of data entry, date/time of data entry, and the specific data in question, are all recorded by the program 110 in the Illicit Data folder, which is a component of the specific databases 113, 114 related to the individual patient, medical agent of record, institution, and data source. If the data entry is substantiated as being illicit, the data source is subject to disciplinary action (e.g., suspension of clinical privileges, termination, arrest/prosecution), which is recorded in the collective local, regional, national, and international Scorecard databases 113, 114.

d) A data entry requiring editing (i.e., alteration) must first be recorded in the databases 113, 114 by the program 110 as an “edited” data entry and have an authorized/credentialed second independent party for validation of the requested edit. The timing and nature of the requested edit is recorded by the program 110 for additional auditing and/or review, depending upon the nature of the data being edited, the identity of the source requesting data edit, and/or the timing of the edit. As an example, a pharmacy technician may determine that the patient identification recorded for drug dispersal is erroneous. Before the editing of the input data can be completed, documentation must be recorded by the program 110 as to the nature of the edit, identification of the medical agent and patients in question, and source of the error. Before the data edit can be completed, a second independent party must validate the changes to be made.

It is important to note that the identification and authorization of all parties recording and/or accessing data is performed using Biometrics. At the time of attempted log-on into the Scorecard database 113, 114, the party is authenticated by the program 110, and the program 110 will retrieve and review the requested data records for security access, records security, and accuracy. Higher levels of data access/recording will likely require a second Biometrics authentication by the program 110.

Compliance standards can be determined at local (e.g., institutional), regional (e.g., healthcare network), or national (e.g., governmental) levels, and implemented by the program 110. Any perceived violation of a compliance standard automatically triggers an external review by the program 110 for further action.

Compliance profiles are created for all stakeholders, institutions, and medical agents, by the program 110, to ensure that corresponding data is complete, accurate, and reproducible. One of the most common concerns for compliance is the timely recording of all relevant data, which may not take place due to human oversight (either intentional or unintentional). Errors of omission are of particular concern, since missing data leads to ineffective and erroneous data analysis.

In order to ensure maximum compliance with data recording policies, the following measures are introduced by the program 110:

a) Automated alerts for missing and/or incomplete data entry (e.g., physician fails to input data related to therapeutic response to an administered pharmaceutical).

b) Safeguards preventing delayed data input (e.g., inability to retrospectively enter data beyond a pre-defined period of time following task completion).

c) Suspension of privileges (e.g., database access) if data input violations is determined to achieve a defined threshold (e.g., frequency of occurrence).

d) Periodic auditing of patient, source, medical agent, and institutional Scorecard databases 113, 114 to ensure compliance standards are being met in accordance with established policies and industry standards.

e) Separate category of Scorecard analysis dedicated to Compliance, to provide an objective measure of individual compliance.

These institutional, individual stakeholder, and agent-specific compliance scores become an integral part of the overall quantitative analysis, which can have important implications as to overall safety, effectiveness, and economic scores. As an example, an institution with a sub-standard compliance score related to documentation and treatment of adverse drug events may receive a lower financial reimbursement as a result. If and when this institutional compliance score is corrected to meet the standard requirement, the financial reimbursement may be increased commensurate with the documented improvement. The program 110 keeps track of all these compliance issues.

f) Patient compliance is of equally high importance within the Scorecard, for without active patient participation, overall clinical outcomes suffer. In order to ensure patient compliance is maintained a number of external measures and technologies may be integrated into the Scorecard.

The subject of patient compliance is of particular importance to the Scorecard invention, and plays an important role in medical agent safety, effectiveness, and economics. Each individual patient will have his/her own individual Scorecard database 113, 114, where the program 110 tracks and stores data related to each medical agent and disease, and correlates that information with data intrinsic to the patient's own profile. Patient profile data includes personalized data related to patient demographics, body habitus, genetics, clinical data (e.g., laboratory, imaging, pathology), and compliance.

Examples of individual metrics used to quantify patient compliance include (but are not limited to) the following, which information is stored in the databases 113, 114 by the program 110:

a) Filling prescriptions.

b) Taking prescribed medications as directed.

c) Reporting any adverse actions or changes in health status.

d) Keeping scheduled appointments.

e) Providing requisite clinical feedback to designated healthcare professionals.

f) Utilizing healthcare technology to assist in data collection (e.g., at home glucose monitoring, blood pressure measurements).

g) Reporting lost or stolen medications.

h) Following medical directives for required clinical testing (e.g., blood work testing liver enzymes).

i) Providing accurate and updated healthcare records.

j) Reporting any change of address or location to healthcare professionals involved in medical care.

k) Participation in patient oriented educational initiatives.

It is reasonable to assume that the more proactive patients are in their own healthcare, the potential exists for improved clinical outcomes. Patient compliance and proactive participation is especially important in pharmaceutical delivery, in order to ensure the agent and dosage is being administered as recommended, clinical feedback is being provided for treatment optimization, and potential adverse actions are detected and acted upon promptly to minimize morbidity and mortality.

Analysis of patient compliance by the program 110 can be performed in a number of ways including (but not limited to) the following:

a) Self-reporting—In self-reporting, either the patient or primary caregiver would enter data related to prescription filling, administration, therapeutic response, and adverse actions (e.g., allergic reaction) into the computer database 113, 114. The program 110 would then initiate a method of accurate record keeping, which could entail an electronic (or analog) tracking device, in which the responsible party would record each event and add text as needed, etc. A timing device could be generated by the program 110, which could issue an alert in keeping with the dosing schedule of each individual pharmaceutical, which would prompt the patient or care giver each time a pre-determined event arrived. This could entail a number of events including (but not limited to) physician appointments, medication dosing, clinical testing (e.g., glucose monitoring). In order to ensure compliance and accurate reporting, the program 110 could correlate the reported data inputs with both the patient's individual database 113, 114 record and those of comparable patients. Whenever a missed data or data outlier was identified, the primary stakeholders of record (e.g., physician, pharmacist, home nurse) would be electronically notified by the program 110, with electronic confirmation receipt being issued and stored. Any ensuing actions or communications would in turn be recorded by the program 110 in the stakeholder, patient, and medical agent databases 113, 114.

b) External human reporting—In external human reporting, responsible stakeholders like the primary care physician or pharmacist would report pertinent data related to patient compliance metrics and record it in the database 113, 114. As an example, if a patient missed a physician appointment, the physician would report this event to the corresponding patient and medical agent databases 113, 114. Another example would include pharmacist reporting of a missed pharmaceutical refill. In the event of a “high priority” event, all primary stakeholders (as defined by the event) would be automatically alerted by the program 110 by stored communication methods, and ensuing actions would be recorded by the program 110 in the database 113, 114 for clinical outcomes analysis. Human reporting can also entail subjective data inputs (e.g., physician providing a subjective assessment of patient timeliness and responsibility to adhering to outpatient pharmaceutical administration, which is recorded in the database 113, 114), which can be periodically reviewed and analyzed by the program 110 and/or stakeholders for accuracy and reproducibility. Statistical analysis of the databases 113, 114 by the program 110 can identify inherent biases in subjective data reporting (e.g., physician who consistently provides lower subjective data inputs for a given patient, relative to the same patient's other healthcare provider data inputs) and make statistical adjustments to the data.

c) Technology-derived reporting—This category of reporting enlists the input of automated reporting technologies using the program 110, which can derive automated measurements related to compliance and automatically record them in the corresponding patient and medical agent databases 113, 114. As an example, a device can be programmed using software program 110, which stores all pharmaceuticals for a given patient, alerts the patient at each dosing interval via predetermined communication means (i.e., fax, text, email, etc.), records inventory in the database 113, 114 or inventory system 31, documents individual drug administration (by recording the amount, type, and date/time of individual pharmaceutical removal in the database 113, 114), and correlates clinical data measures (e.g., blood pressure, pulse). In the event that a critical event was recorded (e.g., two consecutive “missed” administrations, low inventory requiring refill, abnormal recording of clinical test data, unplanned removal of multiple pharmaceuticals), an automated alert would be transmitted by the program 110 via predetermined communication means to the appropriate stakeholders (e.g., pharmacist, physician, nurse) for intervention.

d) Statistical correlation—This category of compliance monitoring would entail the program 110 correlating individual patient compliance data with those of his/her historical records, as well as those of comparable patients (as defined by the patient clinical profile, medical agents, and healthcare providers). In the event that a statistical outlier was identified by the program 110, automated alerts would be sent using predetermined communication means, for further analysis by independent parties (e.g., hospital compliance officer, independent pharmacologist, and statistician). The reliability and intrinsic value of this compliance tool would be directly related to the accuracy, size, and standardization of data within the collective databases 113, 114.

Once the patient compliance data and corresponding metrics have been standardized and validated by the program 110 for accuracy/reproducibility, a number of ensuing actions can take place to improve compliance and clinical outcomes. The first of these actions is education, which has the program 110 providing customized data to each patient in order to educate them as to the criticality of compliance and importance in effecting positive healthcare outcomes. Creation of educational material would be directly derived from data within each patient's database 113, 114 and meta-analysis of clinical outcomes by the program 110. Participation in these educational programs (by patients and their primary caregivers) would be integrated into the patient-specific compliance scores by the program 110, creating an incentive to become proactive in education events.

Another derived action of the patient compliance data can be economic. In the current economic healthcare model, there is no direct financial incentive for patients to maximize their own individual compliance in healthcare directives. (Indirectly, most patients realize that optimal compliance translates into improved clinical outcomes.) Using individual and meta-analysis of the data by the program 110, individual compliance metrics and comprehensive scores can be used to create financial incentives and penalties, commensurate with patient compliance. The scaling of these financial measures can be tied to a number of variables by the program 110 including (but not limited to):

1) The criticality of single compliance metrics.

2) The frequency of compliance metrics.

3) The comprehensive compliance scores.

4) Temporal trending of compliance measures.

5) Extent of deviation from the statistical mean.

Patients who consistently demonstrate high levels of individual healthcare accountability; through high compliance scores and continuing education would be financially rewarded. This can take a number of forms including reduction in overall medical insurance premiums, decreased co-pays and deductibles, healthcare rebates, and reduced healthcare taxation. By creating objective and data-driven financial incentives for improved patient compliance, clinical outcomes can potentially be improved, while simultaneously reducing the collective cost of healthcare delivery. This analytical approach to compliance analysis need not be limited to patients alone, but can also be used for individual healthcare and institutional service providers, as well as pharmaceutical and medical device manufacturers.

The program 110 may also utilize the compliance data to derive research applications, including, among others—clinical outcomes analysis, testing of new medical agents seeking regulatory approval, and refinement of treatment protocols in accordance with patient compliance. For clinical outcomes analysis, researchers could utilize the compliance data generated and analyzed by the program 110, to identify the cause and effect relationship patient compliance has on the success or failure of an individual treatment for a specific disease. As an example, in the treatment of congestive heart failure, meta-analysis of the databases 113, 114 by the program 110, may identify that patients with high compliance scores fare better (i.e., improved clinical outcomes) using a certain pharmaceutical, as opposed to low-complaint patients, who do better with a second pharmaceutical. These differences in clinical outcomes for two pharmaceuticals may be due to different safety profiles, for example. In one example, the first pharmaceutical may demonstrate improved cardiac contractility, but have more severe adverse actions when not promptly detected. As a result, low compliance patients who do not reliably monitor and communicate side effects of the pharmaceuticals they are taking, do not do well with this particular medication. These low-compliant patients, instead fare better clinically with another pharmaceutical which produces less cardiac contractility, but does so with a higher safety profile.

In the testing of new drugs and determination of dose optimization, manufacturers and researchers can utilize patient compliance data generated by the program 110 to improve their knowledge as to a given drug's safety and effectiveness profiles. One of the current requirements for clinical trials' drug testing is to identify a given drug's performance in specialized patient groups. By including patient compliance data generated by the program 110 in the regulatory analysis, a greater understanding can be realized in determining a given drug's safety, effectiveness, and dosage requirements. Certain drugs may prove to be more or less effective with differing levels of patient compliance, and this knowledge is important in determining optimal treatment regimens and preventive measures for improved patient safety.

A number of data analytics can be derived from the Scorecard database 113, 114 by the program 110, reflecting the relative patient safety, clinical effectiveness, and economic efficacy of the medical agent in question. In addition, individual stakeholder or institutional performance can be analyzed relative to reference peer groups. As an example, a patient who is seeking long term medical care for a chronic disease (e.g., diabetes), may elect to review the comparative safety and effectiveness scores of several individual and institutional providers in his/her local geographic area. The patient can generate a query for the program 110 to search the database 113, 114, by inputting a specific disease (e.g., diabetes) or medical agent (e.g., glucophage) into the computer system 100, and then list the search criteria of interest. In this particular example, the patient elects to search based upon a geographic radius of 20 miles (given a specific zip code) and searches institutional and physician providers, in accordance to their respective safety and effectiveness ratings. The program 110 would then provide the patient with a list of institutional and physician providers within the defined geographic area in hierarchical order. Each listed provider would in turn have an itemized listing of the individual components which entered into the collective analysis. If, for example, the patient was particularly interested in a physician with excellent communication skills, he/she may initiate a search with Communication as the highest priority variable. By doing so, the program 110 would modify the data presentation to rank physician providers in accordance to how each scores in the specific category of Communication.

In addition to this type of single type of analytical query, a number of combination analyses can be performed by the program 110, which take into account multiple search criteria. In one example, a patient's physician has recommended changing hypertension medications. The patient is interested in learning the comparative effectiveness and safety ratings of the two different brand name drugs, as well as the comparative effectiveness and safety of their generic equivalents. Since the patient's prescription drug coverage has a large co-pay, he/she is also interested in determining the comparative cost-efficacy of these different treatment options.

The query is generated for program 110 action by inputting the different drugs of interest into the computer system 100, with the program 110 providing the option of including both generics and brand name pharmaceuticals. Once the option of selecting both generics and brand name pharmaceuticals is presented by the program 110 to the user, and the response is recorded in the database 113, 114, the program 110 requests the specific type of analysis to be performed. The patient may select the option for collective analyses of Safety, Effectiveness, and Cost, among other options.

In addition to collective scores in each category for each individual drug of interest, the program 110 also presents the following ratios:

1) Safety/Effectiveness ratio.

2) Safety/Cost ratio.

3) Effectiveness/Cost ratio.

In the example, the patient is provided with the information by the program 110, that the safety/effectiveness ratio is higher for drug B (the newly recommended drug), as opposed to drug A (the former drug being used). When comparing the generic and brand name equivalents for drug B, the safety/effectiveness profile is slightly higher for the brand name version; but this is counteracted by a significant difference per unit dose cost. The patient is presented with information by the program 110 that the 5% difference in safety and effectiveness is offset by a 30% price differential.

Upon seeing these comparative data on the display 102, the patient elects to transmit this data to his/her physician via electronic or other communication means (i.e., email, facsimile, text etc.), and requests a consultation with the physician based upon the Scorecard data presented by the program 110. This consultative feature is included in the functionality of the database 113, 114 by selecting the Consultation option presented by the program 110, and inputting the consultant of record for program 110 recordal.

After discussing the options, both the patient and physician agree that the generic equivalent of drug B is the optimal choice given the patient's financial restrictions, clinical history, and overall safety/clinical performance of the drug options. The ability to utilize the database 113, 114 for decision support is an important feature of the program 110 and the decision support options can be customized by the program 110 based upon individual preferences and occupational differences of end-users.

In addition to the comprehensive “Scorecard” compiled by the program 110 of the present invention, a number of individual “Scorecards” can be derived from subsections of data within the all-inclusive (collective) databases 113, 114. They include the following categories: 1) individual healthcare providers (e.g. physician, nurse, pharmacist); 2) patients, 3) institutional providers (e.g., hospital, pharmacy, distributor), 4) manufacturers, 5) researchers (e.g., investigators, statisticians, CROs), and 6) payers (e.g., governmental, private insurers, HMOs).

These specialized Pharmaceutical (or Medical Device) data can provide pharmaceutical-related data analytics specific to the entity of principal interest. As an example, individual healthcare provider scorecards (e.g., physician, pharmacist) can be provided by the program 110, which analyzes Safety, Clinical Effectiveness, and Economics specific to an individual provider. These provider-specific “Scorecards” can be specific to a single pharmaceutical, group of pharmaceuticals (e.g., used in the treatment of a specific disease or clinical indication), or all collective pharmaceuticals. The program 110 provides data-driven, targeted analysis for any interested party (e.g., patient) to perform a comparative analysis, using standardized data on how different providers perform relative to a given pharmaceutical(s), treatment of a specific disease or clinical indication, or specific patient profile.

In addition to individual healthcare provider “Scorecards”, institutional “Scorecards” can be derived by the program 110, which analyzes collective and individualized performance related to pharmaceutical delivery. The data analyses and presentation formats can be customized by the program 110 to the individual preferences of the reviewer (an important feature), so that data can be presented by the program 110 as to how the individual institution of record compares to national, regional, local, or individual reference institutions. Institutional profiles can be used by the program 110 in order to perform comparative analyses of institutions with similar demographics, size, geography, technical/human resources, and services.

Another often overlooked group for specialized “Scorecards” would be patients, who are a critical group in determining pharmaceutical performance. Patient-specific data variables (i.e., demographics, compliance, education, clinical profile) are important in determining the relative safety, clinical effectiveness, and economics of a given pharmaceutical, and are considered by the program 110 in predicting and evaluating clinical outcomes. As an example, if different patients were evaluated with the same disease (e.g., diabetes) and were being treated with pharmaceuticals, one might expect different clinical outcomes in accordance with multiple data points, including: 1) body habitus, 2) co-morbidities, 3) pharmaceutical profile (current and previous), 4) compliance, 5) education, and 6) genetics.

If one patient has a longstanding history of non-compliance with his/her medications, this would impact selection of therapy (e.g., selection of a long acting agent requiring less frequent dosing), as well as clinical effectiveness expectations. Due to documented non-compliance by the program 110, the patient would be expected to have a less favorable clinical outcome than a comparable patient with high compliance; and as a result, have a greater degree of co-morbidity and increased overall healthcare cost. Thus, patient non-compliance has the potential to adversely affect pharmaceutical safety, clinical effectiveness, and economics. This potential for patient-specific compliance to adversely impact economics, plays an important role in pharmaceutical analysis and should be fact considered in pharmaceutical selection and price. In the same manner that automobile insurance providers offer discounted rates to customers with high performance indicators (e.g., accident history, education); the same application can be made with medical insurance providers. Those patients demonstrating higher compliance and education scores (based upon objective data analysis), could have lower medical insurance rates or discounts applied to pharmaceutical purchases. The program 110 provides quantitative accountability to pharmaceutical economic analysis, based upon data-driven patient specific performance indicators.

Patient education is another variable which has the potential to impact pharmaceutical safety, clinical effectiveness, and economics. Patients who proactively engage in educational efforts are more likely to improve safety by identifying and communicating adverse or allergic reactions earlier than their non-educated counterparts. As a result, pharmaceutical clinical effectiveness and economics would improve. Proactive patient education and feedback would also provide valuable information for healthcare providers as to the specific types of educational programs deemed most effective. Thus, the program 110 provides a mechanism to customize educational programs specific to individual patient needs and preferences. If patient participation in educational programs can be shown (through prospective analysis of the database 113, 114) by program 110 analysis, to result in incremental improvement to a given pharmaceutical's safety, clinical effectiveness, and/or economics, then an incentive should be realized by those participating patients. These incentives can be provided by a number of sources, including but not limited to pharmaceutical manufacturers, third party payers, or institutional providers.

It is important to note that these entities will in all likelihood, market products and services to those patients with the highest performance data scores, due to the fact that having “higher performance patients” in their data pool, with elevate their own individual performance metrics. As an example, an insurance provider may attempt to selectively market services to “higher performance” patients, at the expense of “lower performance” patients. This can be statistically accounted for in the program's 110 Scorecard analysis by statistically correcting for patient profile differences, so as not to skew a given insurance company's performance scores in favor of “high performance” patients. An additional factor to consider is that patients will be motivated to improve their own individual performance scores (i.e., through increased compliance, education) when data-driven incentives are realized.

Other patient specific variables (e.g., genetics, clinical profile) also play important roles in determining differences in pharmaceutical safety, clinical effectiveness, and economics. By the program 110 collecting and analyzing these data, valuable information can be derived by the program 110 in optimizing pharmaceutical selection, identification of potential adverse actions, and expected clinical response to medical therapy.

In addition to patient and provider-specific “Scorecards”, institutional “Scorecards” (e.g., pharmacies, hospitals) can be derived by the program 110, which analyzes pharmaceutical performance (i.e., safety, clinical effectiveness, and economics) relating to patient profiles and disease states. A patient relocating to a new geographic area could utilize this data provided by the program 110 to select the optimal institutional provider.

In addition to disease and patient-profile specific safety and effectiveness data, institutional-specific economic data can be utilized by the program 110 so to compare a given pharmaceutical's unit cost. This is important when one considers pharmaceutical cost differentials between institutional providers in different countries. A pharmacy operating in Canada, for example, may offer a given pharmaceutical at a significantly lower cost than a pharmacy operating in the United States. Given the availability to electively purchase pharmaceuticals on line (i.e., via the Internet), the program 110 would provide potential consumers with objective data related to safety, clinical effectiveness, and cost. For example, the foreign provider, who offers a given pharmaceutical at a greatly reduced discount, may also have lower safety scores (e.g., counterfeiting, reduced purity), which would be important data to consider when comparing pharmaceutical providers. With the program 110 standardizing and externally validating the recorded data, the program 110 can comparatively analyze providers for users with a high degree of accuracy.

Manufacturer-specific “Scorecards” could also be derived from the database 113, 114 by the program 110. This would include both Pre and Post-Approval data and can be used to evaluate individual manufacturer performance as it relates to single or multiple pharmaceuticals. In one example, a large (health insurance) third party payer wants to analyze safety, clinical effectiveness, and economic measures for a given pharmaceutical manufacturer. In this example, a given manufacturer has poor safety data scores attributed to four (4) individual pharmaceuticals, but high scores for all others it produces. In reviewing and analyzing this data, the insurance investigators learn that the safety scores for one of the pharmaceuticals was due to clinical oversight during the Clinical Trials (i.e., Pre-Approval data), which has since been corrected, with high Post-Approval safety scores. The poor safety data attributable to the other three (3) pharmaceuticals is the result of recent post-approval data, and can therefore, not be discounted. The insurance investigators conclude that it is in the best interest of the company and its customers to exclude these three (3) pharmaceuticals from the “acceptable” list of pharmaceuticals which will be covered under the insurance plan. If an individual customer (i.e., patient) elected to purchase one of these three (3) pharmaceuticals, they would not be entitled to full reimbursement by the carrier.

Given knowledge of their performance record, the pharmaceutical manufacturer has several options to address the poor safety record of these three (3) pharmaceuticals:

a) Pull them from the market.

b) Offer discounts (which in turn will positively impact the safety/cost ratio).

c) Increase marketing efforts for those specific pharmaceuticals of concern.

In addition to providing valuable data to patients, healthcare providers, third party payers' pharmaceutical manufacturers would also derive important data from these manufacturer Scorecards provided by the program 110. The program 110 can provide the manufacturer with information such that the manufacturer can objectively determine how their products match up to their competitors (relative to safety, clinical effectiveness, and cost), what specific pharmaceuticals have relatively deficient data requiring re-evaluation, what clinical niches and patient profiles are best suited by that companies higher performing products, where future R & D efforts need to be focused, and how outsourcing certain processes (e.g., packaging) has effected product performance data.

Another category of “Scorecards” that could be compiled by the present invention, is that of researchers, which is of importance in the analysis of Pre-Approval data. A number of individual and collective entities are involved in the Clinical Trials data collection and analysis, required for FDA pharmaceutical or medical device approval. Study investigators, statisticians, and contract research organizations (CROs) all have critical stakes in the final determination of pharmaceutical approval and since they relay on payment from the pharmaceutical manufacturer, they are subject to potential bias. In order to objectively analyze the performance of these researchers, the program 110 provides a research “Scorecard” which can incorporate safety, clinical effectiveness, and economic data specific to an individual or group of pharmaceuticals, in which the specific research entity has participated in data collection and analysis. The data recorded by the researcher into the databases 113, 114 can in turn be correlated by the program 110 with “downstream” (i.e., Post-Approval) data, to correlate the reported Clinical Trial and Clinical data measurements. This will not only shed light on potential discrepancies, but the program 110 also provides a cumulative performance record of the researcher in question. At the same time, reported economic compensation provided to the researcher would be incorporated into the Scorecard by the program 110 to provide an accurate gauge as to the economic requirements for pharmaceutical approval, researcher-specific compensation, and any potential penalties or fines issued by regulatory oversight agencies.

By the program 110 recording and analyzing this data related to pharmaceutical research, a reproducible mechanism is created to gauge the collective records of researchers and the manufacturers that support them. Researchers could potentially be motivated to be less biased in their study conclusions, when they realize that longitudinal data analysis will expose any shortcomings or deficiencies in study methodology, data collection, reporting, and analysis.

Payer “Scorecards” of the present invention are one important tool for healthcare consumers to correlate the clinical and economic decisions a given third party payer makes in effecting clinical outcomes. The reimbursement rate a payer makes to a pharmaceutical company is predicated on perceived value and competitiveness in the marketplace, and this in turn affects treatment options and cost for the consumer. The pharmaceutical reimbursement rates are incorporated by the program 110 into the Payer “Scorecard”, along with the rates it is charging its customers. For a given prescription insurance plan, the payer's operational and product costs should be recorded into the Scorecard database 113, 114 by the program 110, relative to individual patient, institutional, and pharmaceutical profiles. When certain pharmaceuticals are given priority status by the payer (i.e., inclusion in a drug formulary, preference for generic over brand name), corresponding safety, clinical effectiveness, and economic data are presented by the program 110, along with comparative data of pharmaceutical alternatives.

As noted above, patient specific profile data are reported and analyzed along with differential rates being charged for insurance coverage, by the program 110. If, for example, an insurance company has placed a specific patient into a “high risk/cost” category, then the corresponding data accounting for this increased cost is provided by the program 110. At the same time, any discounts, rebates, or preferred pricing provided to patients (i.e., for increased compliance and/or educational scores) are incorporated by the program 110 into the analysis for validation and verification.

The data within the payer “Scorecard” can also serve as an objective measure of cost/benefit analysis, and petition for adjustment in care is provided by the program 110. As an example, a patient (or his/her physician) may request that an insurance company pay for a specific brand name pharmaceutical, instead of the generic equivalent. In making this request, the patient and/or physician cites higher safety and/or clinical effectiveness scores for the brand name pharmaceutical, specific to the patient profile data. Based on comparative analyses of the two pharmaceuticals performed by the program 110 (i.e., brand name and generic), the insurance administrator determines that the relative difference in safety and/or clinical effectiveness does not justify the increased expenditure. The patient and/or physician appeals this decision to a neutral third party (e.g., Insurance Commissioner) using the data provided by the program 110, which includes pharmaceutical, disease, and patient-specific data. The Insurance Commissioner in turn elects to use certain data derived ratios (e.g., safety/cost, clinical effectiveness/cost) to determine that the small, but reproducible differences between the two pharmaceuticals can be justified given the patient and disease profiles in question. In addition, the insurance company must provide this comparative data to all of its insured customers, who may be affected by the pharmaceuticals in question.

Thus, an integral component of the Payer Pharmaceutical “Scorecard” provided by the program 110 is the comprehensive safety, clinical effectiveness, and economic scores each payer receives based upon their cumulative record relating to pharmaceutical payment, selection, and authorization. This provides standardized data to prospective customers, for informed and data-driven decision-making in the selection of insurance companies.

In order to illustrate how the invention works, a number of scenarios are described in the following examples, which illustrate, in small part, how various safety and effectiveness data (relative to medical pharmaceutical and devices) are recorded, analyzed, and acted upon by the program 110 of the present invention.

### Example 1

In one example, a patient wants to review the database 113, 114 for comparison of safety and effectiveness profiles of a specific type of medical device (e.g., cardiac pacemaker) and service providers (e.g., interventional cardiologist).

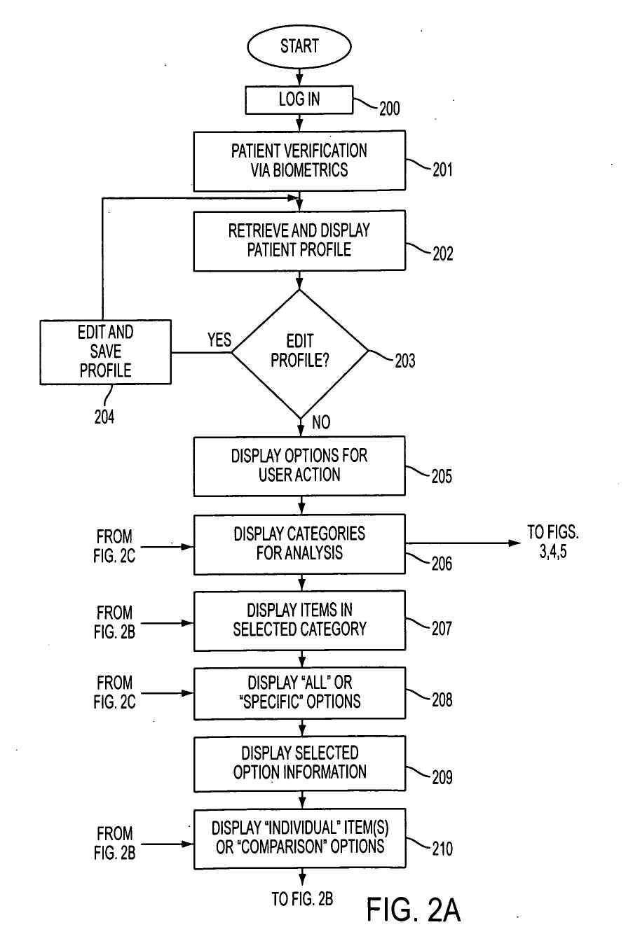

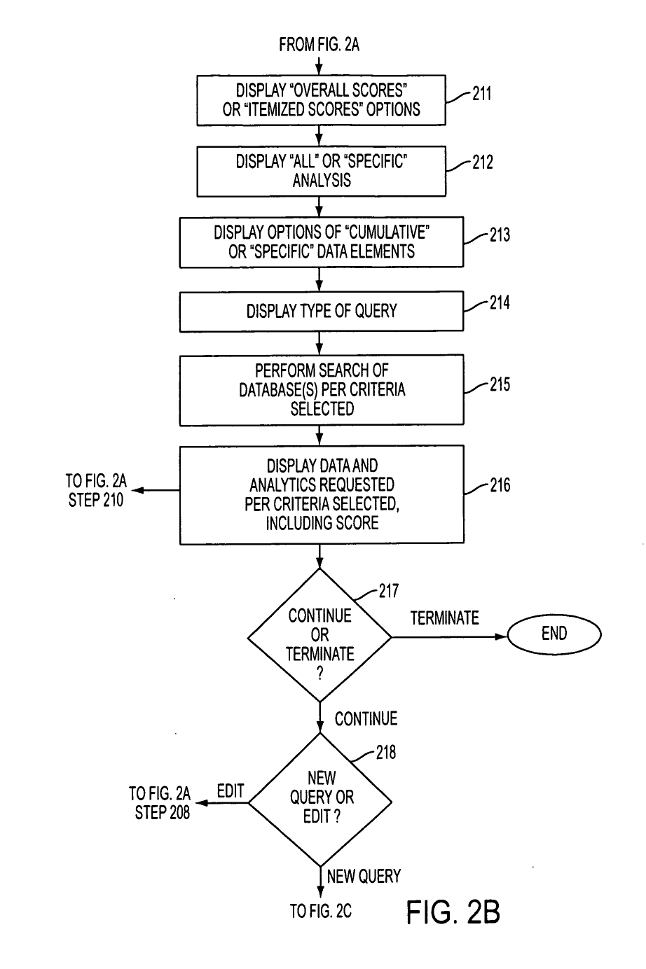

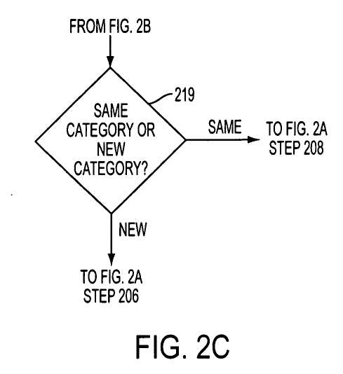

Specifically, the patient (John Smith) is diagnosed by his primary care physician with a new cardiac arrhythmia, with the recommendation of a cardiac pacemaker for treatment. The physician provides Mr. Smith with the names of two local cardiologists for consultation. After making appointments with the two cardiologists, Mr. Smith is provided with conflicting information as to the specific type of cardiac pacemaker for insertion. In order to determine the optimal pacemaker, Mr. Smith elects to consult the national database 113, 114, in order to make an educated and informed decision. The following outlines the various steps and options presented to Mr. Smith by the program 110 in reviewing the available data and which assists him in both determination of the preferred pacemaker and the service provider, and are shown in FIGS. 2A-2C.

In step 200, the Patient logs into the database 113, 114, which may be reached via a secure website, using a login sequence presented by the program 110 (see FIG. 2A).

In step 201, the program 110 presents and conducts a Patient identification and verification system (Biometrics) to the Patient, to ensure that the user (Patient) has the appropriate access.

In step 202, the Patient's individual profile is retrieved from the database 113, 114 by the program 110 and displayed for Patient review, with an option for edits in step 203.

In step 203, the Patient selects the “No Edits” option, and the program 110 proceeds to step 205.

Alternatively, the Patient selects the Edit option and makes alterations to his profile based upon recent changes (i.e., change in weight, new diagnosis of cardiac arrhythmia, change in dosage of cardiac medication), which are then stored by the program 110 in the database 113, 114 in step 204.

In step 205, the program 110 presents options for Patient action (i.e., Query database 113, 114, change Access controls, etc.).

In step 206, the Patient selects “Query”, and the program 110 displays the different types of categories for analysis available (e.g., Medical Devices, Pharmaceuticals, Clinical Providers, Education, Patient, Pharmaceutical Tracking, etc.).

In step 207, the Patient selects a category of analysis (e.g., Medical Devices), and the program 110 displays a list of items in that category.

In step 208, the Patient selects the specific item of interest (e.g., a particular cardiac pacemaker), and the program 110 presents the Patient with two (2) options: 1) “All” items (i.e., all cardiac pacemakers—for general information), and 2) “Specific” items (i.e., for specific information on a particular type of cardiac pacemaker).

In step 209, the Patient selects the “Specific” option desired, and the program 110 displays a list of items with detailed information (i.e., pacemakers by manufacturer and model number). With general information, a summary is provided.

In step 210, the Patient is presented by the program 110 with the option of information on a) one or more items, or b) a comparison of two or more items.

In step 211, the Patient selects the “comparison” option, and then the two items of interest from the pick list, and the program 110 presents the Patient with two (2) options by the program 110, to either receive a) Overall Scores (i.e., composite numerical rankings and scores based upon all variables within the respective categories), or b) Itemized Scores (i.e., individual scores for the different variables within each category) (see FIG. 2B).

In step 212, the Patient selects “Overall Scores”, and the program 110 provides the user with the following two (2) options: a) “All” (Patients), or b) (Patient) “Specific” analysis (i.e., based upon specific attributes within the patient profile data). In option (b), the patient requests the analysis to be limited to patients with similar profile data to himself.

In step 213, the Patient selects “All Patients”, and then the program 110 presents another option of selecting a subsequent analysis be performed based upon a) the cumulative patient profile or b) specific data elements within the profile (e.g., body habitus).

In step 214, the program 110 presents the user with a list of types of Queries for selection and analysis, such as Safety and Clinical Effectiveness, Operational Efficiency, Security, Compliance with Standards, Economics/Cost Efficacy, etc.

In step 215, the Patient selects Safety and Clinical Effectiveness, and the program 110 then generates a Query or search of the database 113, 114 for Safety and Clinical Effectiveness data with respect to the two particular Medical Devices chosen.

In step 216, the program 110 presents the user with Safety and Clinical Effectiveness data analytics based upon the selected items of a) Medical Devices: Cardiac Pacemaker (Pacemaker Y, Pacemaker Z), b) Overall Scores, and c) All Patients (cumulative analysis), including composite Safety and Clinical Effectiveness scores (i.e., “Scorecard”) as shown in Table 1, for example:

TABLE 1

| | | Composite Clinical |
|---|---|---|
| | Composite Safety Score | Effectiveness Score |
| Pacemaker | (1-100) | (1-100) |
| Pacemaker Y | 45 | 64 |
| Pacemaker Z | 50 | 72 |

In step 217, the Patient is presented by the program 110 with options to “Continue” or “Terminate” the Query. If the user chooses “Terminate”, the program 110 ends and logs out the user.

In step 218, the Patient selects “Continue”, and the program 110 provides the option of a “New Query”, or to “Edit” the previous Query. If “Edit” is selected, the program 110 takes the user back to step 208.

In step 219, the Patient selects the “New Query” option, and the program 110 first presents the user with the option of “Same Category”, or “New Category” (i.e., Medical Device) (see FIG. 2C). If the user selects “New Category”, the program 110 takes the user back to step 206 (see FIG. 2A). If the Patient selects “Same Category”, the program 110 takes the user back to step 208 (see FIG. 2A).

Continuing with this example of a Patient now wanting to check service providers, at step 206, with a new Query, the program 110 provides the Patient with category options, such as Medical Devices, Pharmaceuticals, Clinical Providers, Education, etc.

In step 207, the Patient this time selects “Clinical Provider” for the category for analysis, and the program 110 displays a list of items, such as the following search criteria of the Clinical Providers, for example: a) Institutional, b) Geographic, c) Payer, d) Specialty, and e) Other.

In step 208, the user selects “Geographic” and the program 110 displays two options: 1) “All” (Clinical Providers in a selected Geographic area), or 2) a “Specific” Clinical Provider(s).

In step 209, the Patient chooses “Specific”, and the program 110 displays a list of categories to narrow the list of Clinical Providers: a) Region, b) State, c) City, d) Zip Code, e) Defined mile radius (relative to home location), and f) Other. The Patient can select any category to further define the list, and the program 110 will provide the requested information.

In step 210, the Patient is presented with the option of choosing information on a) one or more Clinical Providers, or b) can compare one or more Clinical Providers. The Patient chooses option a), and chooses two specific names of the two (2) consulting cardiologists, and the program 110 will present all information stored on the individual cardiologists, and then will present the Patient with the options of a) Overall Scores or b) Itemized Scores for the two Clinical Providers in step 211.

In step 212, the Patient chooses “Overall Scores” and the program 110 provides the options of a) “All” (Patients), or b) “Specific” analysis (based upon particular attributes inputted).

In step 213, the Patient selects “All” and the program can provide another option for further analysis.

In step 214, program 110 presents the user with a list of types of Queries for selection and analysis, such as Safety and Clinical Effectiveness, Medical Device, Performance, Cost, etc.

In step 215, the Patient selects Safety and Clinical Effectiveness, and the program 110 then generates a Query or search of the database 113, 114 for Safety and Clinical Effectiveness data with respect to the two particular cardiologists chosen.

In step 216, the program 110 calculates according to a predetermined algorithm, using the variables mentioned supra, and presents the user with Safety and Clinical Effectiveness data analytics for the two cardiologists based upon the selected items of a) Medical Devices Cardiac Pacemaker (Pacemaker Y, Pacemaker Z), b) Overall Scores, and c) All Patients (cumulative analysis), including composite Safety and Clinical Effectiveness scores (i.e., Scorecard) as shown in Table 2, for example:

TABLE 2

| | | Composite Clinical |
|---|---|---|
| | Composite Safety Score | Effectiveness Score |
| Clinical Provider | (1-100) | (1-100) |
| Cardiologist A | 68 | 81 |
| Cardiologist B | 47 | 95 |

In step 217, the Patient elects to “Continue” the Query, and the program 110 will accept the selection of “Edit” Query, by taking the user back to step 208 and the “Geographic” Query. At that step, the Patient can redefine the search criteria to all interventional cardiologists within a 25 mile radius of a specific zip code.

Thereafter, at step 216, the program 110 then provides comparative Safety and Clinical Effectiveness data for all interventional radiologists fulfilling the new search criteria, as shown in Table 3, for example.

TABLE 3

| | | Composite Clinical |
|---|---|---|
| | Composite Safety Score | Effectiveness Score |
| Clinical Provider | (1-100) | (1-100) |
| Cardiologist A | 68 | 81 |
| Cardiologist B | 47 | 95 |
| Cardiologist C | 55 | 24 |
| Cardiologist D | 32 | 65 |
| Cardiologist E | 92 | 91 |
| Cardiologist F | 14 | 70 |
| Cardiologist G | 88 | 72 |
| Cardiologist H | 6 | 14 |

The Patient can click on any one of the Clinical Providers in Table 3 (for example, Cardiologist E, due to his/her superior Safety and Clinical Effectiveness score), and the program 110 will return the Patient to step 210, where further information on the Cardiologist is provided. Based upon the specific profile provided by Cardiologist E, the following data is presented by the program 110 to the patient: Office location, Office contact number, Insurance accepted.

Thus, the Patient can elect to call the provided office contact number for an appointment, based upon the fact that Cardiologist E participates in his insurance plan.

In addition, the program 110 provides a Consultation option with the data on the Clinical Provider, such that the program 110 can notify Cardiologist E of the search data analyzed (including the patient profile), for his/her review at the time of the patient visit.

The Patient can “Terminate” the Query in step 217, and all the search data is recorded by the program 110 into a master database 113, 114 by at least Patient name, and other information, such as Clinical Provider, which stores the information sought and received during the course of the Query.

### Example 2

In another example, a Physician wants to review his/her personal Scorecard scores and wants to utilize the data to drive continuing medical education (CME) efforts for personalized data improvement.

In this example, an internal medicine physician (Dr. A. Perez) electively wants to review his individual Scorecard in order to determine his relative strengths and weaknesses related to pharmaceutical administration. He will in turn utilize this information to guide future efforts, while also requesting the program 110 provide him with automated data analytics related to those specific analyses of interest.

The Physician logs into the database 113, 114, and follows the same steps as in steps 200-205 above.

In step 206, the Physician selects “Query”, and the program 110 displays the different types of categories for analysis available (e.g., Medical Devices, Pharmaceuticals, Clinical Providers, Clinical Effectiveness, Education, Patient, Pharmaceutical Tracking, etc.).

In step 207, the Physician selects the category of analysis: Pharmaceuticals—and the program 110 displays a list of Pharmaceutical profiles (i.e., antibiotic, hypertensive, etc.) for selection.

In step 208, the Physician selects one profile, and the program 110 displays two options: 1) “All” (Pharmaceuticals), or 2) a “Specific” Pharmaceutical.

In step 209, the user chooses “All”, and the program 110 displays a list of categories to narrow the list: Institution, Patient profile, Disease profile, Clinical Provider, Time Frame, Other.

In step 210, the Physician can choose a) one or more categories for the particular Pharmaceutical, or b) can compare one or more Pharmaceuticals in a particular category.

The Physician chooses option a), and chooses his name from the Clinical Provider list, as well as inputs his Institution, all age ranges for Patient profile, all Diseases, and a time frame of 12 months. The program then presents the Physician with all the information on his patients, covering all diseases, in the last 12 months at his Institution.

In step 211, the program 110 will present the Physician with the option of choosing a) Overall Scores, or b) Itemized Scores, and the Physician selects “Overall Scores”.

In step 212, the program 110 provides the options of a) “All” Patients, or b) Patient “Specific” analysis (based upon particular attributes inputted).

In step 213, the Physician selects “All” and the program can provide another option for further analysis, if required.

In step 214, the program 110 presents the user with a list of types of Queries for selection and analysis, such as Safety and/or Clinical Effectiveness, Performance, Cost, etc.

In step 215, the Physician selects Clinical Effectiveness, and the program 110 then generates a Query or search of the database 113, 114 for Clinical Effectiveness data with respect to the particular Pharmaceutical search criteria.

In step 216, the program 110 calculates according to a predetermined algorithm, and presents the user with the user's Clinical Effectiveness data analytics for the chosen Pharmaceuticals at his Institution, over the last 12 months, on his Patients having all Disease profiles. The Physician's Clinical Effectiveness score is 43, with a range of 12-66.

In step 217, the Physician can choose “Continue”, and in step 218, can “Edit” the Query to obtain an itemized analysis of those individual categories with Clinical Effectiveness Scores Below 25.

The Physician then enters the new search data in step 213, for example, and the program 110 can display the following information in step 216: scores below 25 belong to Patients aged 65-74, with a particular Pharmaceutical Profile: Antibiotic, Anti-hypertensive, and having a Disease Profile: Hypertension, Diabetes.

The Physician can click on the individuals, or choose from a menu selection for the program 110 to retrieve individual patient-specific data—i.e., individual patient records fulfilling search criteria for Physician review.

From his review of the data, the Physician identifies following areas of performance concern:
a) Elderly patients with urinary tract infections.
b) Elderly patients with poorly controlled hypertension, receiving multiple medications.
c) Diabetic patients being treated with a recently approved medication.

The Physician then returns to step 206, by entering “Continue”, and “New Query”, and the program 110 displays the different types of categories for analysis available (e.g., Medical Devices, Pharmaceuticals, Clinical Providers, Education, Pharmaceutical Tracking, etc.).

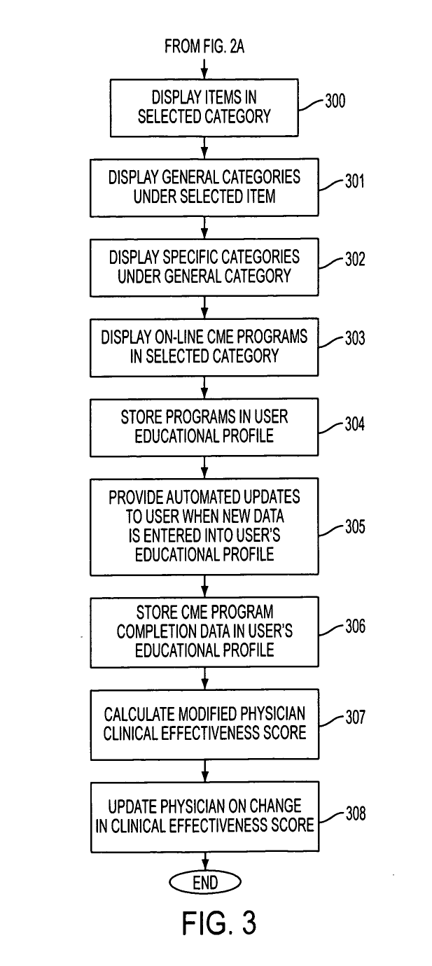

In step 300 (see FIG. 3), the Patient selects a category of analysis of “Education”, and the program 110 displays a list of items in that category, i.e., Disease Categories, Board Certifications, Educational Programs, etc.

In step 301, the Physician selects “Disease Categories”, and the program 110 presents the following general categories: Infectious Diseases, Cancer, etc.

In step 302, the Physician selects one or more categories, and the program 110 presents a number of specific categories for selection.

In step 303, the Physician selects: Diabetes, Hypertension, and Infection, Urinary Tract, and the program 110 presents the user with multiple on-line Continuing Medical Education (CME) options targeting pharmaceutical selection for the disease categories of interest.

In step 304, the Physician selects those CME programs of interest and requests that the program 110 download the programs into his Educational Profile, which is performed by the program 110.

In step 305, the program 110 automatically provides the Physician with automated data updates to be sent to him as new data in each of the selected categories is entered into the Physician's Educational profile database 113, 114.

When each of the CME programs is completed by the Physician, the program 110 will record the completion date, subject matter, and test scores in the Physician's Educational profile in step 306.

In step 307, the program 110 will then in turn calculate and produce a modification in the Physician's Clinical Effectiveness scores, based upon an algorithm which provides a score increase of a predetermined percentage based upon educational achievement.

In step 308, as new Clinical Effectiveness data is recorded in those specific categories of interest, the Physician will be automatically notified by the program 110 of changes in his Clinical Effectiveness performance.

In the event that specific Clinical Effectiveness scores remain lower than desired (i.e., lack of completion of CME in a required period of time, or failure of the CME program), the Physician can elect to have automated or in person Pharmacologist consultations, whenever the pre-defined clinical criteria are realized (e.g., newly diagnosed urinary tract infection in elderly male with diabetes). If the consultations increase the Clinical Effectiveness score over time, the program 110 will notify the Physician as in step 308.

### Example 3

In this example, an Administrator wants to utilize data compiled by the present invention specific to an individual patient event to determine the underlying etiology and contributing factors of an adverse event (i.e., root cause analysis), along with implementing measures to avoid future repeats.

In this scenario, an elderly patient dies unexpectedly during a relatively uneventful hospital admission for pneumonia. An autopsy reveals that the patient died of a myocardial infarction, although no pre-existing history of cardiac disease was documented in the patient. In the hopes of determining whether medical error contributed to the patient's death, the information related to the patient that was stored in the database 113, 114, was reviewed by a nursing administrator, with a detailed analysis of the events preceding death.

In this scenario, the login steps shown in FIG. 2A, steps 200-205, are the same. In step 206, the Physician selects “Query”, and the program 110 displays the different types of categories for analysis available (e.g., Medical Devices, Pharmaceuticals, Clinical Providers, Clinical Effectiveness, Education, Patient, Pharmaceutical Tracking, etc.), and the Administrator selects “Patient”.

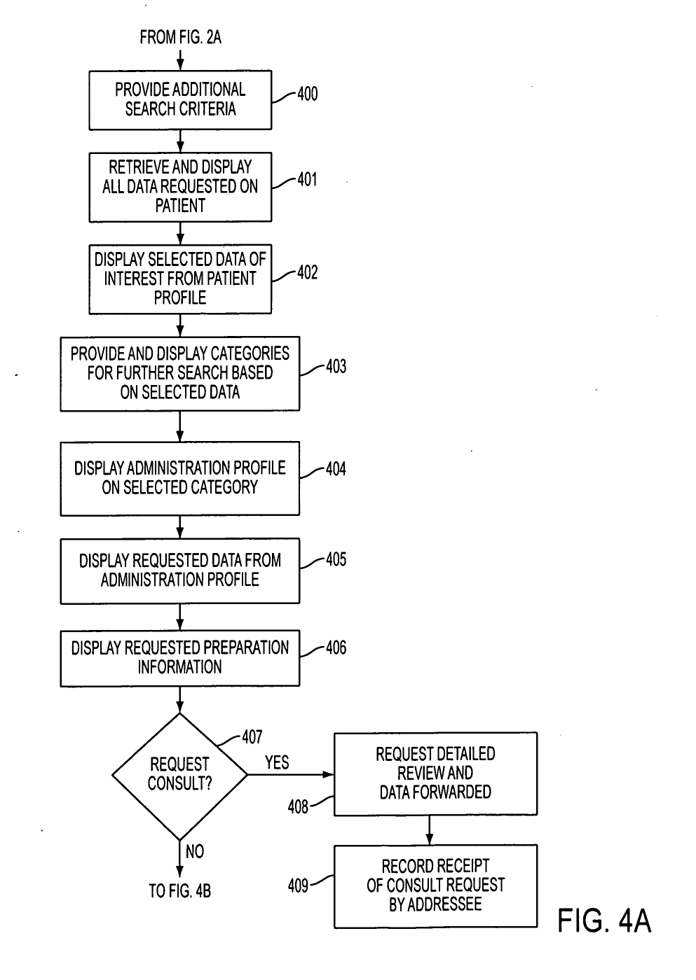

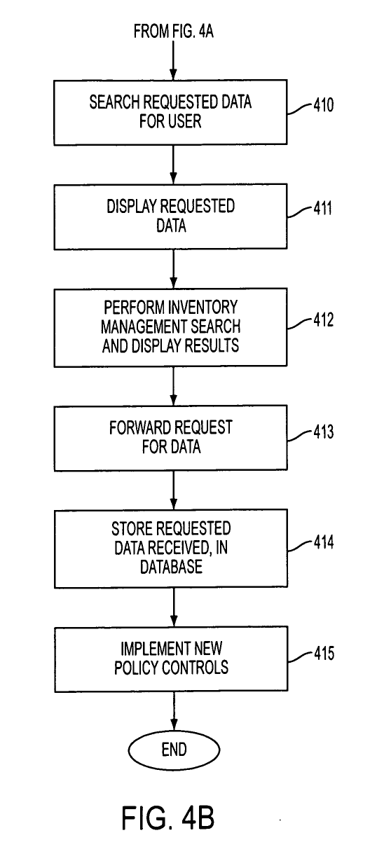

In step 400 (see FIG. 4A), the program 110 provides a list of criteria for Patient search to narrow the search.

In step 401, the user selects a particular Patient Name and Date, and the program 110 retrieves all Patient information and all data referenced to the date in question available for the Administrator's review.

In step 402, the Administrator selects the specific data of interest from the patient's individual profile, such as: a) Clinical diagnosis, b) Pharmacology, c) Clinical testing, d) Allergies, e) Medical and surgical history, and f) Medical Device data, and the program 110 displays the information to the user.

When reviewing the Pharmacology data, the Administrator learns the patient had been receiving three medications at the time of her death including 2 antibiotics and an anticoagulant.

In step 403, the Administrator selects the Pharmaceuticals, and then the program 110 provides a list of categories for further selection—i.e., Administration Profile, Safety Data, etc.

In step 404, the Administrator selects the Administration Profile for these Pharmaceuticals and the program 110 presents the following data for each pharmaceutical: a) Date and time of administration, b) Dosage, c) Preparation, d) Location, e) Route of administration, and f) Responsible caregivers.

In step 405, the Administrator selects “Data and Time”, and the program 110 presents information that one of the antibiotics was administered within one (1) hour of the time of death.

From the information, the Administrator learns that the specific drug, dosage, and route of administration were consistent with the prescribed order, and were signed off by the patient's nurse and ordering physician.

In step 406, the Administrator requests drug preparation information (i.e., pharmacy information), and the program 110 presents the requested information to the user.

When reviewing the preparation of the drug, the Administrator notes that the pharmacist of record was a temporary pharmacist who was filling in for the regular pharmacist. All pharmacy records show that there was no error documented during preparation of the pharmaceutical.

In step 407, the program 110 issues a request for Consult, which the user can accept or ignore. In this case, the nursing Administrator accepts and issues the Consultation request using the program 110, to the pharmacologist for detailed review of the case, with all relevant data from the query automatically transferred to him in step 408.

In step 409, the program 110 records confirmation of Receipt at the time the pharmacologist receives the consultation request.

In step 410 (see FIG. 4B), the pharmacologist initiates a separate Query of the Pharmaceutical database 113, 114, focused on the Pharmaceutical of record and the day/time of the event, and the program 110 searches the database 113, 114 for the information.

In step 411, the program 110 displays the information that only two (2) other patients in the hospital received the same drug administered intravenously on the date in question, one of which was prepared with an hour of the patient in question.

In step 412, the user institutes an Inventory Management “Query” of the database 113, 114, and the program 110 determines that the prescribed dose for the unaffected patient was two times that of the patient who died, although the correct dosage was recorded in the pharmacy database for both patients.

The pharmacologist is concerned that human error was the cause of the death, due to a reversal in patient dosages, which was not recorded in the Pharmacy inventory.

In step 413, the pharmacologist issues a request to obtain an antibiotic serum level from the deceased patient's blood, and the program 110 forwards the appropriate request to the appropriate party.

In step 414, the program 110 uploads the results of the antibiotic serum level in the database 113, 114, and forwards same automatically to the attention of the pharmacologist via predetermined communication means (i.e., fax, email, etc.), showing that the excessively high levels of the antibiotic in question were present in the deceased patient's blood.

In step 414, the pharmacologist accesses a pharmacology database 113, 114, and the program 110 provides reviews of the antibiotic profile, where it demonstrated that a rare but well documented side effect of excessive dosage was cardiac arrhythmia, which could have served as the cause of a myocardial infarction.

As a result of this investigation, and that of committee meetings with the pharmacologist, administrator, physician, etc., a new policy was instituted calling for an amended policy of intravenous drug preparation and documentation, and the program 110 implements those controls in step 415.

### Example 4

In this example, a Pharmacist wants to review the security data related to the procurement and distribution of controlled substances within his/her organization to identify areas of relative deficiencies requiring intervention.

In this scenario, undocumented controlled substances were being unaccounted for by the hospital pharmacy. In keeping with governmental mandates, the chief pharmacist needed to launch an investigation to identify the source of the disappearing controlled substances and institute safeguards to prevent future actions from reoccurring. In order to objectively accomplish this task and document compliance with institutional and governmental standards a formal inquiry is performed which is recorded by the program 110 in the quality assurance and security databases 113, 114 of the specific pharmaceutical in question. This particular search and Query utilizes tracking functionality contained within the program 110. Specifically, this relies on the ability of the program 110 to objectively track all transactions for a given medical agent throughout the supply chain cycle, accounting for individual medical agent lot numbers, involved personnel, along with time stamped inventory management and tracking using the inventory system 31. The following steps illustrate one example of the desired functionality.

The initial steps are the same as steps 200-206.

In step 206, the Pharmacist enters the desired Query and analysis of interest—i.e., Pharmaceutical Tracking.

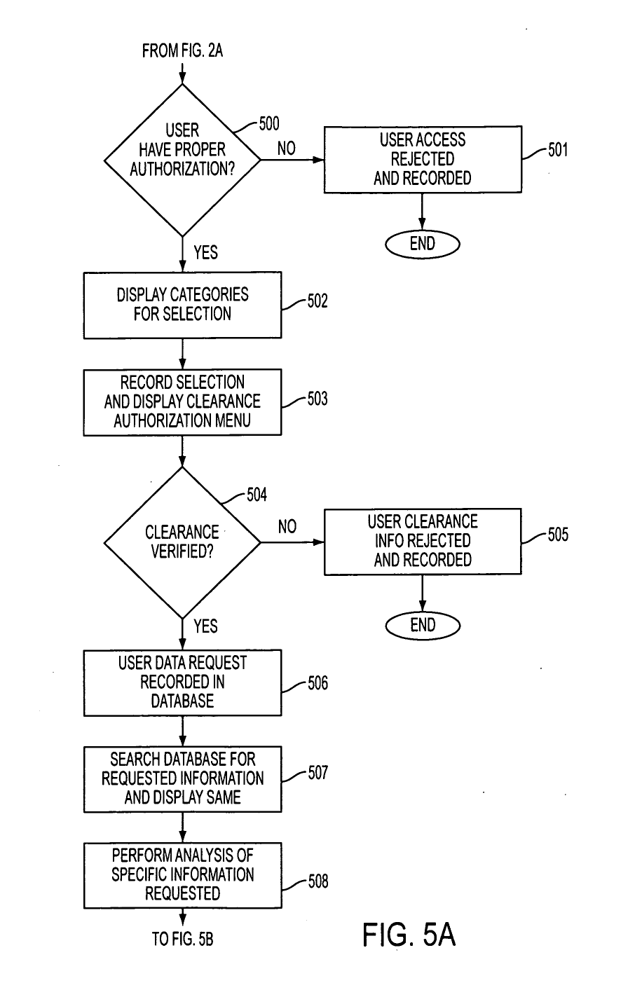

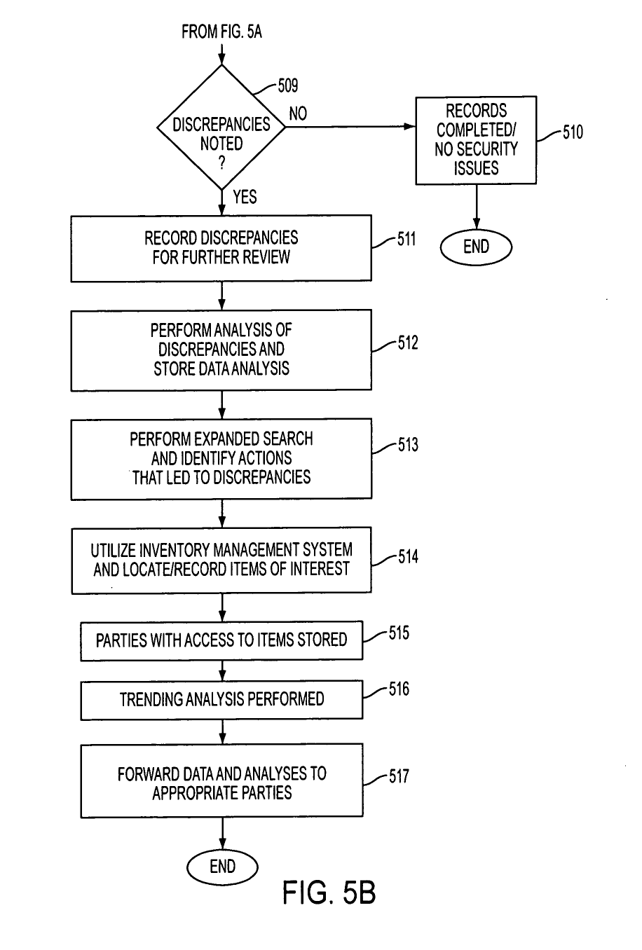

In step 500 (see FIG. 5A), the program 110 determines whether the pharmacist has the appropriate authorization based upon his/her database credentials, as an additional layer of security. If the pharmacist's credentials are authenticated, the program 110 allows the pharmacist to proceed.

If the pharmacist's credentials are not authenticated, a rejection is given and the data related to the requested database Query is recorded by the program 110 for security analysis (by authorized IT and management personnel) in step 501, and the Query ends.

In step 502, after authorization has been granted to the pharmacist, the program 110 provides a list of categories for selection, including Pharmaceuticals, Medical Devices, Surgical Scheduling, etc., and the pharmacist chooses Pharmaceuticals for selection.

In step 503, the pharmacist enters the specific Pharmaceutical agent of interest, which is recorded in the database 113, 114 and, in this case, the program 110 then provides another authorization for the user to ensure that the requestor has clearance for database Query and analysis of the defined controlled substance (e.g., Oxycontin™).

In step 504, the program 110 receives the user's inputted clearance information, and if the pharmacist's credentials are authenticated, the program 110 allows the pharmacist to proceed. If the pharmacist's credentials are not verified, a rejection is given by the program 110 in step 505, and the data related to the requested database Query is recorded by the program 110 for security analysis (by authorized IT and management personnel), and the Query ends.

Once authentication and verification has been completed, the specific data of interest is inputted into the database 113, 114, including security databases 113, 114, by the user, and recorded by the program 110 in step 506. For this specific data query (Pharmaceutical tracking), the pharmacist inputs the specific steps in the tracking process of interest (i.e., Distribution, Procurement, Ordering, Dispersal) along with the specific dates/times, locations, institutions, and personnel for analysis. The input of these search variables can be done through a variety of input commands including, but not limited to, pick lists on the user interface, typing in search terms, and speech commands.

Once the pharmacist has inputted the steps required, the medical agent, location, and dates/times of interest in step 506 above, the database 113, 114 is searched by the program 110, and the program 110 provides an itemized listing of all transactions fulfilling the defined criteria in step 507.

In the data provided, the specific pharmaceutical lot numbers are provided based upon RFID (or other tracking technology) tags assigned to each shipment of the medical agent of interest. Depending upon the security interest of each Pharmaceutical, these tags can be assigned on different levels of granularity (e.g., case, bottle individual pill).

In step 508, upon request, the program 110 can perform systematic analysis of the pharmaceutical-specific RFID tags (or other tracking technology) to determine which specific lot(s) were not completely accounted for throughout the entirety of the supply chain steps of interest.

In this analysis, the database 113, 114 is cross-referenced by the program 110 to determine the identities of all involved personnel, actions performed, locations, and date/times of each transaction.

These transactions are also cross-referenced by the program 110 with all physician orders, patient records, and pharmacist dispersals, to ensure that documentation is complete and accurate, and that no potential trends for fraudulent activity has taken place.

The program 110 then determines in step 509 (see FIG. 5B), whether discrepancies or outliers were identified in the analysis. If no outliers are identified by the program 110 in this analysis, then the program 110 determines in step 510, that the database Query and analysis is completed with no record of impropriety.

Any outstanding concerns by the pharmacist are referred to the pharmacy quality assurance/compliance officer for further review, and the Query ends.

If discrepancies or outliers (i.e., unaccounted data) are identified by the program 110 in step 509, these are recorded by the program 110 in the pharmaceutical quality assurance/security databases 113, 114 for further review and scrutiny in step 511. During this expanded analysis, the tracking numbers of the unaccounted for medical agents are identified by the program 110 and entered into the pharmaceutical tracking database 113, 114 in step 512.

Specifically, the program 110 identifies the date/time of the last data record, and then an expanded search is performed by the program in step 513, to identify actions that led to the discrepancies, such as identifying all personnel and subsequent actions taken for the specific medical agent in question. As an example, if another lot of the same medical agent was accessed by a pharmacist two (2) hours following the last recorded date/time of the lot of interest, this is recorded as a potential security breech by the program 110, due to the fact that the pharmacist had access to the missing lot in performing his/her duties on another recorded lot.

The window of concern is narrowed according to the inventory management system 31 employed, and the program 110 utilizes the inventory management system 31 to locate and record the number of each pharmaceutical lot at pre-defined time intervals, in step 514.

In step 515, all potential parties with access to the missing medical agent are recorded in the database 113, 114 for longitudinal analysis.

In step 516, trending analysis is performed by the program 110, over time, to determine if future instances of unaccounted for pharmaceuticals can be traced back to potential repeat offenders.

Surveillance techniques (e.g., hidden visual monitors) can be initiated to provide additional evidence if/when repeated episodes take place.

In step 517, the ongoing security data and analyses are automatically sent by the program 110 to the appropriate administrative parties for further action, as well as to the appropriate governmental and criminal agencies in the event that further investigation and/or prosecution are warranted. The administrative parties would include, among others, a centralized data repository for review by pharmacies or institutional service providers who are interested in background investigations for prospective new hires.

### Other Examples

In other examples, a third party payer wants to update a drug formulary relative to a specific classification of pharmaceuticals (e.g., antibiotics), based upon the features of clinical effectiveness, safety, and economics. With the above program 110, the third party payer would be able to add this data to the databases 113, 114 for retrieval by the Physician, or other users.

In another example, a governmental regulator (e.g., JCAHO) wants to utilize data contained within an institutional Scorecard to identify specific safety and security concerns related to pharmaceutical administration. With the above program 110, security data can be retrieved and used by the governmental regulator to address those concerns.

In yet another example, a pharmaceutical industry executive wants to utilize the national Scorecard database 113, 114 to review the comparative safety and effectiveness profiles of competing pharmaceuticals within a specific class (e.g., Cox-2 inhibitors). As noted above, the program 110 can perform this comparison easily and efficiently for the user.

In yet a final example, a nursing supervisor wants to review an institutional Scorecard database 113, 114 to review compliance standards related to documentation of drug-related adverse events. The program 110 can perform this review in order to ensure compliance standards.

Thus, in summary, the present invention provides an itemized analytical tool which creates a series of standardized and objective metrics related to each individual step in the overall process of pharmaceutical development and delivery. The individual steps can be divided into two main sections: pre and post regulatory approval. Pre-approval data analysis relates to the various steps involved in clinical trials, while post-approval analysis relates the multiple steps related to everyday use. The data analytics take into account the various contributions individual stakeholders and institutions play in determining overall safety and effectiveness of medical agents. The agent-specific data can in turn be cross referenced with individual patient and disease specific data, in order to provide customizable decision support.

An internal quality assurance (QA) mechanism can be integrated to ensure accuracy and reproducibility of the data used for analysis.

By utilizing standardized data elements, data can be pooled across multiple sample sites to create large-scale statistics, which in turn can be used to generate best clinical practice (EBM) guidelines.

The individual and collective data analyses can be presented at the point of care to assist in optimizing patient safety, operational/economic efficiency, and clinical effectiveness.

All data will be recorded (e.g., raw, unprocessed, and processed) for analysis; thereby providing a mechanism to ensure compliance with universal data standards.

Data-driven analyses will be provided to assess individual institution, stakeholder, and company performance; as it relates to medical agent safety and efficacy. The derived data analyses can in turn generate automated alerts and prompts whenever a critical data threshold has been realized; with end-user time stamped data documenting receipt and acknowledgment of the critical data in question. The derived data analyses will be made available to healthcare consumers for the purposes of medical education and assistance in selection of medical agents and service providers.

Longitudinal meta-analysis can be used to identify failure of compliance with established universal guidelines; and used for disciplinary actions related to individual manufacturers, institutions, and professionals.

The data created by this invention can be directly integrated (in a non-proprietary fashion) into existing medical information system technologies; to ensure universal data access, collection, and analyses.

Finally, customizable end-user profiles and filters can be incorporated to provide customized data analyses in keeping with the specific needs of individual stakeholders and patients.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of compiling a score for a medical device or medical agent, comprising:
providing a user of a client computer with a list of items for analysis, said items being one of medical devices or medical agents;
displaying options for providing general information on all items in said category, or specific information on a particular item in said category;
displaying options for information on one or more items in said category, or a comparison of two or more items in said category;
displaying options for one of overall scores for an item based upon composite numerical rankings and scores based upon all variables within predetermined categories, or itemized scores based upon individual scores for variables within each of said predetermined categories;
displaying options for analysis of said at least one item with respect to at least one of safety and clinical effectiveness, operational efficiency, security, compliance with standards, economics, cost efficacy;
calculating and displaying a score based upon predetermined variables and said analysis, for said at least one item.
